(19) United States
(12) Patent Application Publication
(10) Pub. No.: US 2023/0312889 A1
(43) Pub. Date: Oct. 5, 2023

(54) POLYMER COMPOSITION, METHOD FOR PRODUCING SAME, FORMULATION, CROSSLINKED PRODUCT, AND TIRE

(71) Applicant: ENEOS Materials Corporation, Tokyo (JP)

(72) Inventors: Akihiko OOKUBO, Tokyo (JP); Tetsuya YAMAMOTO, Tokyo (JP); Junjie WANG, Tokyo (JP); Rikimaru KUWABARA, Tokyo (JP)

(73) Assignee: ENEOS Materials Corporation, Tokyo (JP)

(21) Appl. No.: 18/189,357

(22) Filed: Mar. 24, 2023

(30) Foreign Application Priority Data
Mar. 29, 2022 (JP) 2022-054000
Nov. 30, 2022 (JP) 2022-192336

(51) Int. Cl. C08L 9/06; C08F 236/10

(52) U.S. Cl. CPC C08L 9/06; C08F 236/10; C08L 2205/025

(57) ABSTRACT

Provided is a polymer composition containing (A) a modified conjugated diene-based polymer which includes a monomer unit derived from a conjugated diene compound and has a molecular weight distribution Mw/Mn of 1.50 to 3.00 and in which some or all of the molecules are modified, the molecular weight distribution being represented by a ratio of polystyrene-equivalent weight-average molecular weight Mw to number-average molecular weight Mn measured by gel permeation chromatography, and (B) a surfactant having HLB of 9.0 or less and having an oxypropylene group, the polymer composition further containing (C) an extender oil as an optional component, in which a total amount of the modified conjugated diene-based polymer (A), the surfactant (B) and the extender oil (C) is 95 mass % or more based on the entire composition.

### CROSS-REFERENCE TO RELATED APPLICATIONS

The present application claims priority to Japanese Patent Application No. 2022-054000, filed on Mar. 29, 2022, and Japanese Patent Application No. 2022-192336, filed on Nov. 30, 2022, and thus the contents thereof are incorporated herein by reference.

### BACKGROUND OF THE INVENTION

### Field of the Invention

The present disclosure relates to a polymer composition, a method for producing the same, a formulation, a crosslinked product, and a tire.

### Description of the Related Art

Conjugated diene-based polymers that are obtained by polymerization using a conjugated diene compound are favorable in terms of a variety of characteristics such as heat resistance, wear resistance, mechanical strength and moldability and are thus widely used in a variety of industrial products such as pneumatic tires, anti-vibration rubber and hoses. For example, it is known that a reinforcing agent such as carbon black or silica is, together with a conjugated diene-based polymer, blended with a formulation that is used for the production of treads, sidewalls and the like of pneumatic tires in order to improve the durability or wear resistance of products.

As the conjugated diene-based polymer, a variety of modified conjugated diene-based polymers in which a functional group that interacts with silica has been introduced into a terminal or main chain of a conjugated diene-based polymer chain have been proposed in order to obtain tires having superior low fuel consumption performance. Modified conjugated diene-based polymers are more compatible with a reinforcing filler such as carbon black or silica than unmodified conjugated diene-based polymers and are thus capable of improving low fuel consumption performance by suppressing the generation of heat in tire uses.

In addition, conventionally, in order to further improve tire characteristics such as low fuel consumption performance, it has been proposed to blend an additive with a solution containing a conjugated diene-based polymer obtained by a polymerization reaction and then carry out desolvation (see JP 2017-508841A and JP 2019-182996A). JP 2017-508841A discloses that rolling resistance, tensile strength or the like is improved by blending a dispersant such as bis(2-hydroxyethyl)isotridecyloxypropylamine to a solution containing a modified conjugated diene-based polymer. In addition, JP 2019-182996A discloses that quality stability and silica dispersibility are improved by producing a rubber bale by adding a nonionic surfactant such as di(polyoxyethylene) stearyl amine to a solution containing a modified or unmodified conjugated diene-based polymer.

### SUMMARY OF THE INVENTION

The following means is provided by the present disclosure.

[1] A polymer composition includes:

(A) a modified conjugated diene-based polymer which includes a monomer unit derived from a conjugated diene compound and has a molecular weight distribution Mw/Mn of 1.50 to 3.00 and in which some or all of molecules are modified, the molecular weight distribution being represented by a ratio of polystyrene-equivalent weight-average molecular weight Mw to number-average molecular weight Mn measured by gel permeation chromatography; and

(B) a surfactant having HLB of 9.0 or less and having an oxypropylene group (—C₃H₆—O—). The polymer composition further includes:

(C) an extender oil as an optional component. Total amount of the modified conjugated diene-based polymer (A), the surfactant (B) and the extender oil (C) is 95 mass % or more based on the entire composition.

[2] A formulation includes the polymer composition of the above-described [1] and a reinforcing filler (D).

[3] A crosslinked product is obtained using the formulation of the above-described [2].

[4] A tire includes either or both of a tread and a sidewall formed of the formulation of the above-described [2].

[5] A method for producing a polymer composition includes: mixing a polymer solution dissolving (A) a modified conjugated diene-based polymer in an organic solvent and (B) a surfactant to obtain a liquid mixture; and removing the solvent from the liquid mixture obtained by the mixing, for desolvation. The modified conjugated diene-based polymer (A) includes a monomer unit derived from a conjugated diene compound and has a molecular weight distribution Mw/Mn of 1.50 to 3.00 and in which some or all of molecules are modified, the molecular weight distribution being represented by a ratio of polystyrene-equivalent weight-average molecular weight Mw to number-average molecular weight Mn measured by gel permeation chromatography. The surfactant (B) has HLB of 9.0 or less and has an oxypropylene group (—C₃H₆—O—).

### DESCRIPTION OF THE EMBODIMENTS

As a result of the present inventors' studies, it has been clarified that, in a case where a polymer composition is produced by blending an additive with a solution containing a conjugated diene-based polymer and then carrying out desolvation as in JP 2017-508841A or JP 2019-182996A, the degree of contamination of discharged water that is generated at the time of producing the polymer composition is relatively high and the transportability of the discharged water is poor. In addition, it has been also clarified that a disadvantage of being incapable of sufficiently suppressing a change in performance at the time of having stored the polymer composition for long period of time is caused. As a polymer composition that is used for the production of rubber products, there has been a demand for a technique for improving the transportability of discharged water while suppressing the contamination of the discharged water during production and for obtaining a crosslinked product being excellent in terms of tensile characteristics and low fuel consumption performance while suppressing a change in physical properties caused by the long-term storage of the polymer composition.

The present disclosure has been made in consideration of the above-described problems and a main objective of the present disclosure is to provide a polymer composition that improves the transportability of discharged water that is generated at the time of producing the polymer composition while suppressing the contamination of the discharged water, is capable of suppressing a change in physical properties caused by the long-term storage of the polymer composition and, furthermore, enables the obtainment of a crosslinked product being excellent in terms of tensile characteristics and low fuel consumption performance.

The present inventors have carried out intensive studies to solve the above-described problems of the related art. As a result, they have found that the above-described problems can be solved by a polymer composition containing a modified conjugated diene-based polymer having a molecular weight distribution within a specific range and a specific additive substance.

According to the present disclosure, it is possible to produce a polymer composition that improves the transportability of discharged water that is generated at the time of producing the polymer composition while suppressing the contamination of the discharged water and is capable of suppressing a change in physical properties after long-term storage. In addition, the use of the polymer composition makes it possible to produce a crosslinked product being excellent in terms of tensile characteristics and low fuel consumption performance, as described below.

Hereinafter, items relating to carrying out the present disclosure will be described in detail. In the present specification, numerical ranges expressed using “to” indicate that the numerical values before and after “to” are included as the lower limit value and the upper limit value.

### <<Polymer Composition>>

A polymer composition of the embodiments of the present disclosure (hereinafter, also referred to as “the present composition”) contains (A) a modified conjugated diene-based polymer and (B) a surfactant having HLB of 9.0 or less and having an oxypropylene group (—C₃H₆—O—). Hereinafter, components that are contained in the present composition and a component that is arbitrarily blended will be described.

### <Component (A): Modified Conjugated Diene-Based Polymer>

The modified conjugated diene-based polymer, which is the component (A), (hereinafter, also referred to as “modified conjugated diene-based polymer (A)”) is an aggregate of high molecules having a monomer unit derived from a conjugated diene compound (that is, a molecular aggregate), and some or all of the molecules constituting the modified conjugated diene-based polymer (A) have been modified. The modified conjugated diene-based polymer (A) has a molecular weight distribution Mw/Mn of 1.50 to 3.00, the molecular weight distribution being represented by the ratio of polystyrene-equivalent weight-average molecular weight Mw to number-average molecular weight Mn measured by gel permeation chromatography.

Some or all of the molecules constituting the modified conjugated diene-based polymer (A) are preferably a polymer modified by a compound having one or more elements selected from the group consisting of nitrogen, silicon, sulfur, oxygen and phosphorus, more preferably a polymer having a partial structure derived from a compound having nitrogen and still more preferably a polymer having a partial structure derived from a compound having nitrogen and silicon. Due to a strong effect of improving the dispersibility of a reinforcing filler (particularly silica), in particular, some or all of the molecules constituting the modified conjugated diene-based polymer (A) (that is, the molecules having a monomer unit derived from a conjugated diene compound) preferably have a partial structure derived from a compound having a hydrocarbyloxysilyl group and a nitrogen-containing group in one molecule (hereinafter, also referred to as “modifying agent M”) and more preferably have a structure in which one or more molecular chains including a monomer unit derived from a conjugated diene compound and the modifying agent M has bonded to each other. The modifying agent M will be described in a section “Modification Step”

The modified conjugated diene-based polymer (A) is preferably produced by a method including the following polymerization step and modification step. Hereinafter, the molecular structure and the like of the modified conjugated diene-based polymer (A) will be also described while describing a method for producing the modified conjugated diene-based polymer (A).

### <Polymerization Step>

### (Conjugated Diene Compound)

Examples of a conjugated diene compound that is used in polymerization include 1,3-butadiene, isoprene, 2,3-dimethyl-1,3-butadiene, 1,3-pentadiene, 1,3-hexadiene, 1,3-heptadiene, 2-phenyl-1,3-butadiene, 3-methyl-1,3-pentadiene, 2-chloro-1,3-butadiene and the like. Among these, one or more of 1,3-butadiene, isoprene and 2,3-dimethyl-1,3-butadiene are preferable, and, due to a strong effect of improving processability and reduction of hysteresis losses in a balanced manner, 1,3-butadiene is particularly preferable. As the conjugated diene compound, one conjugated diene compound can be used singly or two or more conjugated diene compounds can be used in combination.

A conjugated diene-based polymer may be a homopolymer for which the conjugated diene compound is used, and is preferably a copolymer having a structural unit derived from the conjugated diene compound and a structural unit derived from an aromatic vinyl compound from the viewpoint of increasing the strength of rubber. Examples of the aromatic vinyl compound include styrene, 2-methylstyrene, 3-methylstyrene, 4-methylstyrene, α-methylstyrene, 2,4-dimethylstyrene, 2,4-diisopropylstyrene, 4-t-butylstyrene, 5-t-butyl-2-methylstyrene, vinylethylbenzene, divinylbenzene, trivinylbenzene, divinylnaphthalene, t-butoxystyrene, vinylbenzyldimethylamine, (4-vinylbenzyl) dimethylaminoethyl ether, N,N-dimethylaminoethylstyrene, N,N-dimethylaminomethylstyrene, 2-ethylstyrene, 3-ethylstyrene, 4-ethylstyrene, 2-t-butylstyrene, 3-t-butylstyrene, vinylxylene, vinylnaphthalene, vinylpyridine, diphenylethylene, tertiary amino group-containing diphenylethylene (for example, 1-(4-N,N-dimethylaminophenyl)-1-phenylethylene) and the like. As the aromatic vinyl compound, among these, styrene or α-methylstyrene is preferable.

In a case where a copolymer of the conjugated diene compound and the aromatic vinyl compound is produced as the conjugated diene-based polymer that is produced in the polymerization step, the conjugated diene-based polymer is preferably a copolymer having a structural unit derived from 1,3-butadiene and a structural unit derived from styrene from the viewpoint of livingness in anionic polymerization. This copolymer is preferably a random copolymer of the conjugated diene compound and the aromatic vinyl compound. The random copolymer may further have a block portion composed of the conjugated diene compound or the aromatic vinyl compound.

The proportion of the aromatic vinyl compound used is preferably set to 3 to 55 mass % and more preferably set to 5 to 50 mass % relative to the total amount of monomers that are used for the polymerization from the viewpoint of well-balanced low-hysteresis loss characteristics (low fuel consumption performance) and wet skid resistance and improvement in wear resistance of the obtained crosslinked product. The content proportion of the structural unit derived from the aromatic vinyl compound in the polymer is a value measured by ¹H-NMR.

Upon the polymerization, a compound other than the conjugated diene compound and the aromatic vinyl compound (hereinafter, also referred to as “additional monomer”) may be used as a monomer. Examples of the additional monomer include acrylonitrile, methyl (meth)acrylate, ethyl (meth)acrylate and the like. In the case of using the additional monomer, the proportion of the additional monomer used is preferably set to 5 mass % or less and more preferably 3 mass % or less relative to the total amount of the monomers that are used in the polymerization.

As a polymerization method, a solution polymerization method is particularly preferable. As the polymerization type, any of a batch type and a continuous type may be used. From the viewpoint of the productivity of the polymer, between them, the continuous type is preferable. In the case of using the solution polymerization method, specific examples of the polymerization method include a method in which monomers are polymerized in an organic solvent in the presence of a polymerization initiator and a randomizer, which is used as necessary. In addition, specific examples of the polymerization method include a method in which an organic solvent, a polymerization initiator and monomers are collectively added to a reaction vessel and a method in which an organic solvent, a polymerization initiator and monomers are continuously or intermittently added to a reaction vessel a plurality of times and polymerized. Among these, the modified conjugated diene-based polymer (A) is preferably produced using the method in which an organic solvent, a polymerization initiator and monomers are continuously or intermittently added to a reaction vessel a plurality of times and polymerized since it is possible to improve the processability of a polymer composition to be obtained and to obtain a crosslinked product being excellent in terms of the dispersibility and tensile characteristics of a reinforcing filler (particularly, silica) in the polymer composition.

As the polymerization initiator, it is possible to preferably use at least one selected from the group consisting of an alkali metal compound and an alkali earth metal compound (hereinafter, also referred to as “initiator INR”). Specific examples thereof include alkyl lithium, 1,4-dilithiobutane, phenyllithium, stilbene lithium, naphthyllithium, 1,3-bis(1-lithio-1,3-dimethylpentyl)benzene, 1,3-phenylenebis(3-methyl-1-phenyl pentylidene)dilithium, naphthyl sodium, naphthyl potassium, di-n-butylmagnesium, di-n-hexylmagnesium, ethoxypotassium, calcium stearate and the like. Examples of the alkyl lithium include methyllithium, ethyllithium, n-propyllithium, n-butyllithium, sec-butyllithium, t-butyllithium and the like. As the alkali metal compound and the alkali earth metal compound, among these, lithium compounds are preferable. Upon the polymerization, the proportions of the alkali metal compound and the alkali earth metal compound used (the total amount in a case where two or more compounds are used) are preferably set to 0.2 to 20 mmol relative to 100 g of the monomers that are used for the polymerization.

The initiator INR that is used in a polymerization reaction may be a metal amide compound that is obtained by mixing an alkali metal compound or an alkali earth metal compound and a compound having a functional group that forms a covalent bond with or interacts with silica (hereinafter, also referred to as “initiating terminal modifying agent”). When monomers are polymerized in the presence of such a metal amide compound, it is possible to obtain a modified conjugated diene-based polymer in which the functional group derived from the initiating terminal modifying agent has been introduced into a polymerization initiation terminal of the conjugated diene-based polymer.

Here, “the functional group that interacts with silica” in the present specification means a group having an element that interacts with silica such as nitrogen, sulfur, phosphorus, oxygen or silicon. “Interaction” means the formation of an intermolecular force that is weaker than a covalent bond (for example, an electromagnetic force that acts between molecules such as an ion-dipole interaction, a dipole-dipole interaction, a hydrogen bond or Van Der Waals force).

The initiating terminal modifying agent is preferably a nitrogen-containing compound such as a secondary amine compound. Specific examples of the nitrogen-containing compound include chain amines such as dimethylamine, diethylamine, dipropylamine, dibutylamine, dodecamethyleneimine, N,N′-dimethyl-N′-trimethylsilyl-1,6-diaminohexane, di-(2-ethylhexyl)amine and diallylamine; cyclic amines such as piperidine, pyrrolidine, hexamethyleneimine, heptamethyleneimine, dicyclohexylamine, N-methylbenzylamine, morpholin, N-(trimethylsilyl)piperazine, N-(tert-butyldimethylsilyl)piperazine and 1,3-ditrimethylsilyl-1,3,5-triazinane.

In the case of polymerizing monomers in the presence of the metal amide compound that is obtained by mixing the alkali metal compound or the alkali earth metal compound and the initiating terminal modifying agent, polymerization may be carried out by mixing the alkali metal compound or the alkali earth metal compound and the initiating terminal modifying agent in advance and adding the mixture to a polymerization system. Alternatively, polymerization may be carried out by adding the alkali metal compound or the alkali earth metal compound and the initiating terminal modifying agent separately or at the same time to a polymerization system and mixing both in the polymerization system. Any of these cases is included in an embodiment of “polymerizing monomers including the conjugated diene compound in the presence of the metal amide compound that is obtained by mixing the alkali metal compound or the alkali earth metal compound and the initiating terminal modifying agent.”

The amount of the initiating terminal modifying agent used is set as appropriate depending on the kind of the alkali metal compound or the alkali earth metal compound. For example, in the case of using metallic lithium, the amount of the initiating terminal modifying agent used is preferably within a range of 0.1 to 1.8 mol and more preferably within a range of 0.2 to 1.0 mol relative to a total of 1 mol of the metallic lithium that is used for the polymerization from the viewpoint of developing processability when used to produce the polymer composition and low fuel consumption performance when used to produce crosslinked products in a well-balanced manner. As the initiating terminal modifying agent, one initiating terminal modifying agent can be used singly or two or more initiating terminal modifying agents can be used in combination.

The randomizer (hereinafter, also referred to as “vinyl group content adjuster”) is used for the purpose of adjusting the vinyl group content that represents the content rate of vinyl bonds in a polymer. Examples of the randomizer include dimethoxybenzene, tetrahydrofuran, dimethoxyethane, diethylene glycol dibutyl ether, diethylene glycol dimethyl ether, 2,2-di(tetrahydrofuryl)propane, 2-(2-ethoxyethoxy)-2-methylpropane, triethylamine, pyridine, N-methylmorpholine, tetramethylethylenediamine and the like. As the randomizer, one randomizer can be used singly or two or more randomizers can be used in combination.

The organic solvent that is used in the polymerization may be an organic solvent that is not active for reactions, and it is possible to use, for example, an aliphatic hydrocarbon, an alicyclic hydrocarbon, an aromatic hydrocarbon and the like. Among these, a hydrocarbon having 3 to 8 carbon atoms is preferable, and specific examples thereof include propane, n-butane, isobutane, n-pentane, isopentane, n-hexane, cyclohexane, propene, 1-butene, isobutene, trans-2-butene, cis-2-butene, 1-hexene, 2-hexene, benzene, toluene, xylene, ethylbenzene, heptane, cyclopentane, methylcyclopentane, methylcyclohexane, 1-pentene, 2-pentene, cyclohexene and the like. As the organic solvent, one organic solvent can be used singly or two or more organic solvents can be used in combination.

In the case of carrying out solution polymerization, the monomer concentration in a reaction solvent is preferably 5 to 50 mass % and more preferably 10 to 30 mass % from the viewpoint of maintaining the balance between productivity and the easiness of polymerization control. The temperature of the polymerization reaction is preferably −20° C. to 150° C. and more preferably 0° C. to 120° C. In addition, the polymerization reaction is preferably carried out at a pressure that is high enough to maintain the monomers substantially in a liquid phase. Such a pressure can be obtained by a method in which the inside of a reactor is pressurized with a gas that is not active for the polymerization reaction or the like. Such a polymerization reaction makes it possible to obtain a conjugated diene-based polymer having an active terminal (more specifically, an alkali metal active terminal or an alkali earth metal active terminal). “Active terminal” in the present specification means a portion that is present at an end of a molecular chain and is other than a structure derived from a monomer having a carbon-carbon double bond (more specifically, a metal terminal).

The 1,2-vinyl group content (hereinafter, also referred to as “vinyl group content”) of the conjugated diene-based polymer having an active terminal is preferably 15 mass % or more and more preferably 20 mass % or more. When the vinyl group content is 15 mass % or more, there is a tendency that favorable wet grip characteristics can be ensured. In addition, the vinyl group content is preferably 70 mass % or less. When the vinyl group content is 70 mass % or less, there is a tendency that favorable low fuel consumption performance can be ensured. From such a viewpoint, the vinyl group content is more preferably 60 mass % or less and still more preferably 50 mass % or less. “Vinyl group content” in the present specification is a value that indicates the content proportion of a structural unit having a 1,2-bond in all structural units of butadiene in the conjugated diene-based polymer and a value measured by ¹H-NMR.

### <Modification Step>

The modified conjugated diene-based polymer (A) is preferably a polymer that is obtained by reacting the alkali metal active terminal or alkali earth metal active terminal in the conjugated diene-based polymer obtained by the polymerization step and a terminal modifying agent. As the terminal modifying agent, the modifying agent M can be preferably used. When the conjugated diene-based polymer having an active terminal and the modifying agent M as the terminal modifying agent are reacted with each other, molecular chains including a monomer unit derived from the conjugated diene compound and the modifying agent M bond to each other, and a modified polymer can be obtained as a molecular aggregate including molecules having a nitrogen-containing group at a main chain terminal or between a terminal and a terminal in the main chain.

The modifying agent M needs to have one or more hydrocarbyloxysilyl groups and one or more nitrogen-containing groups in one molecule. The use of the modifying agent M as the terminal modifying agent makes it possible to further improve a low heat generation property when used to produce crosslinked products, which is preferable. “Hydrocarbyloxysilyl group” is a group in which at least one hydrocarbyloxy group bonds to a silicon atom and refers to a group represented by formula (5).

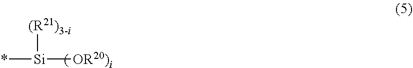

(In the formula (5), R²⁰ and R²¹ are each independently a hydrocarbyl group. i is an integer of 1 to 3. In a case where i is 1, a plurality of R²¹ in the formula is the same as or different from each other. In a case where i is 2 or 3, a plurality of R²⁰ in the formula is the same as or different from each other. “*” represents a bonding site.)

Specifically, the modifying agent M is preferably at least one selected from the group consisting of a compound represented by formula (6), a compound represented by formula (7), a compound represented by formula (8) and a compound represented by formula (9).

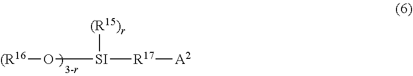

(In the formula (6), A² is a monovalent functional group that has a nitrogen atom, has no active hydrogen and bonds to R¹⁷ with the nitrogen atom. R¹⁵ and R¹⁶ are hydrocarbyl groups, R¹⁷ is a hydrocarbylene group and r is an integer of 0 to 2. In a case where r is 0 or 1, a plurality of R¹⁶ in the formula is the same as or different from each other, and, in a case where r is 2, a plurality of R¹⁵ in the formula is the same as or different from each other.)

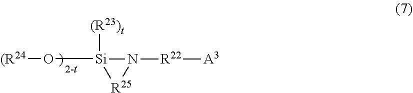

(In the formula (7), A³ is a monovalent functional group that has at least one atom selected from the group consisting of nitrogen, phosphorus, sulfur and silicon, has no active hydrogen and bonds to R²² with a nitrogen atom, a phosphorus atom, an oxygen atom, a sulfur atom or a silicon atom or a hydrocarbyl group having 1 to 20 carbon atoms. R²² is a single bond or a hydrocarbylene group, R²³ and R²⁴ are each independently a hydrocarbyl group, R²⁵ is a hydrocarbylene group and t is 0 or 1. Here, in a case where t is 0, a plurality of R²⁴ in the formula is the same as or different from each other.)

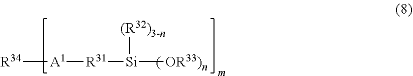

(In the formula (8), R³¹ is a hydrocarbylene group having 1 to 20 carbon atoms, R³² and R³³ are each independently a hydrocarbyl group having 1 to 20 carbon atoms, A¹ is a group “*—C(R³⁵)═N—” or a group “*—N═C(R³⁵)—” (here, R³⁵ is a hydrogen atom or a hydrocarbyl group and “*” indicates a bonding site that bonds to R³⁴.). R³⁴ is an m-valent hydrocarbon group having 1 to 20 carbon atoms or an m-valent group having 1 to 20 carbon atom that has at least one atom selected from the group consisting of nitrogen, oxygen and sulfur and has no active hydrogen. n is an integer of 1 to 3 and m is an integer of 2 to 10. Regarding each reference symbol of R³¹ to R³³ and A¹, in a case where there is a plurality of the same reference symbols in the formula, groups represented by the reference symbol are the same as or different from each other. A plurality of n in the formula is the same as or different from each other.)

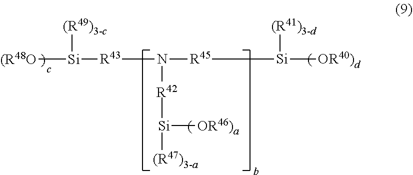

(In the formula (9), R⁴², R⁴³ and R⁴⁵ are each independently an alkanediyl group having 1 to 12 carbon atoms, R⁴⁰, R⁴¹, R⁴⁶, R⁴⁷, R⁴⁸ and R⁴⁹ are each independently a hydrocarbyl group having 1 to 20 carbon atoms. a, c and d are each independently an integer of 1 to 3 and b is an integer of 1 to 10. Regarding each reference symbol, in a case where there is a plurality of the same reference symbols in the formula, groups represented by the reference symbol are the same as or different from each other.)

In the formula (6) and the formula (7), the hydrocarbyl groups represented by R¹⁵, R¹⁶, R²³ and R²⁴ are preferably linear or branched alkyl groups having 1 to 20 carbon atoms, cycloalkyl groups having 3 to 20 carbon atoms or aryl groups having 6 to 20 carbon atoms. R¹⁷ and R²² are preferably linear or branched alkanediyl groups having 1 to 20 carbon atoms, cycloalkylene groups having 3 to 20 carbon atoms or arylene groups having 6 to 20 carbon atoms. R²⁵ is preferably a linear or branched alkanediyl group having 1 to 20 carbon atoms.

A² is a nitrogen-containing group and may be a chain structure or a cyclic structure. The nitrogen atom in A² does not bond to an active hydrogen and may be protected by a protective group (for example, a trisubstituted hydrocarbylsilyl group or the like). A² may be a group capable of turning into an onium ion by an onium salt generator.

Specific examples of A² include a nitrogen-containing group in which two hydrogen atoms of a primary amino group are substituted with two protective groups, a nitrogen-containing group in which one hydrogen atom of a secondary amino group is substituted with one protective group, a tertiary amino group, an imino group, a pyridyl group and the like. Among these, A² preferably has at least one selected from the group consisting of a tertiary amino group, a group in which one hydrogen atom of a secondary amino group is substituted with one protective group and a group in which two hydrogen atoms of a primary amino group are substituted with two protective groups. “Protective group” in the present specification is a functional group that converts a polymerization active terminal of A² into an inactive functional group. The nitrogen-containing group in which one hydrogen atom of a secondary amino group is substituted with one protective group and the tertiary amino group may be chain-like or cyclic.

At least one atom selected from the group consisting of nitrogen, phosphorus, oxygen, sulfur and silicon in A³ does not bond to an active hydrogen and may be protected by a protective group (for example, a trisubstituted hydrocarbylsilyl group or the like). A³ may be a group capable of turning into an onium ion by an onium salt generator.

Specific examples of A³ include a nitrogen-containing group in which two hydrogen atoms of a primary amino group are substituted with two protective groups, a nitrogen-containing group in which one hydrogen atom of a secondary amino group is substituted with one protective group, a tertiary amino group, an imino group, a pyridyl group, a phosphorus-containing group in which two hydrogen atoms of a primary phosphino group are substituted with two protective groups, a phosphorus-containing group in which one hydrogen atom of a secondary phosphino group is substituted with one protective group, a tertiary phosphino group, a group in which a hydrogen atom of a hydroxyl group is protected by a protective group, a sulfur-containing group in which a hydrogen atom of a thiol group is substituted with a protective group, a hydrocarbyloxysilyl group and the like. Among these, A³ is preferably a group having silicon or nitrogen and more preferably a hydrocarbyloxysilyl group, a nitrogen-containing group having a protective group or a tertiary amino group.

In the formula (8), examples of the hydrocarbylene group as R³¹ include an alkanediyl group having 1 to 12 carbon atoms, a cycloalkylene group having 3 to 12 carbon atoms and an arylene group having 6 to 12 carbon atoms. Examples of the hydrocarbyl groups as R³² and R³³ include an alkyl group having 1 to 20 carbon atoms, an allyl group, a cycloalkyl group having 3 to 20 carbon atoms and an aryl group having 6 to 20 carbon atoms.

The m-valent hydrocarbon group as R³⁴ is a group in which m hydrogen atoms have been removed from a hydrocarbon. Particularly, the m-valent hydrocarbon group as R³⁴ is preferably a group in which m hydrogen atoms have been removed from the ring portion of an aromatic hydrocarbon (m-valent aromatic ring group). Specific examples of the aromatic hydrocarbon include monocycles or condensed rings such as a benzene ring, a naphthalene ring and an anthracene ring and structures in which two or more of the above-described rings have been bonded to each other with single bonds.

In a case where R³⁴ is an m-valent group having 1 to 20 carbon atoms that has at least one atom selected from the group consisting of nitrogen, oxygen and sulfur and has no active hydrogen, specific examples thereof include m-valent heterocyclic groups, m-valent groups having a tertiary amine structure and the like. The heterocyclic groups are preferably conjugated heterocyclic groups, and examples thereof include monocycles or condensed rings such as pyridine, pyrimidine, pyrazine, quinoline, naphthalidine, furan and thiophene, groups in which m hydrogen atoms have been removed from the ring portion of a structure formed by linking a plurality of the above-described rings and the like.

m is preferably 2 to 6 from the viewpoint of further improving the processability of the polymer composition. n is preferably 2 or 3 and more preferably 3 since it is possible to further enhance a silica dispersibility-improving effect.

In the formula (9), the alkanediyl groups as R⁴⁵, R⁴² and R⁴³ are preferably linear. Examples of the hydrocarbyl groups as R⁴⁰, R⁴¹ and R⁴⁶ to R⁴⁹ include an alkyl group having 1 to 20 carbon atoms, an allyl group, a cycloalkyl group having 3 to 20 carbon atoms and an aryl group having 6 to 20 carbon atoms.

a, c and d are preferably 2 or 3 and more preferably 3 since it is possible to further enhance a silica dispersibility-improving effect. b is preferably 1 to 5 and more preferably 1 to 3.

As specific examples of the terminal modifying agent, examples of the compound represented by the formula (6) can include N,N-bis(trimethylsilyl)aminopropyltrimethoxysilane, N,N-bis(trimethylsilyl)aminopropylmethyldiethoxysilane, N,N′,N′-tris(trimethylsilyl)-N-(2-aminoethyl)-3-aminopropyltriethoxysilane, 3-(4-trimethylsilyl-1-piperazino)propylmethyldimethoxysilane and the like.

Examples of the compound represented by the formula (7) can include 1-trimethylsilyl-2,2-dimethoxy-1-aza-2-silacyclopentane, 1-triethylsilyl-2,2-diethoxy-1-aza-2-silacyclopentane, 2,2-dimethoxy-1-(3-trimethoxysilylpropyl)-1,2-azasilolidine, 2,2-dimethoxy-1-phenyl-1,2-azasilolidine, 2-(2,2-dimethoxy-1,2-azasilolidine-1-yl)-N,N-diethylethan-1-amine and the like.

Examples of the compound represented by the formula (8) can include compounds represented by the following formula (m-1-1) to formula (m-1-8), respectively, compounds in which an alkyl group and an alkanediyl group in the above-described compound each have been substituted with an alkyl group having 1 to 6 carbon atoms or an alkanediyl group having 1 to 6 carbon atoms and the like.

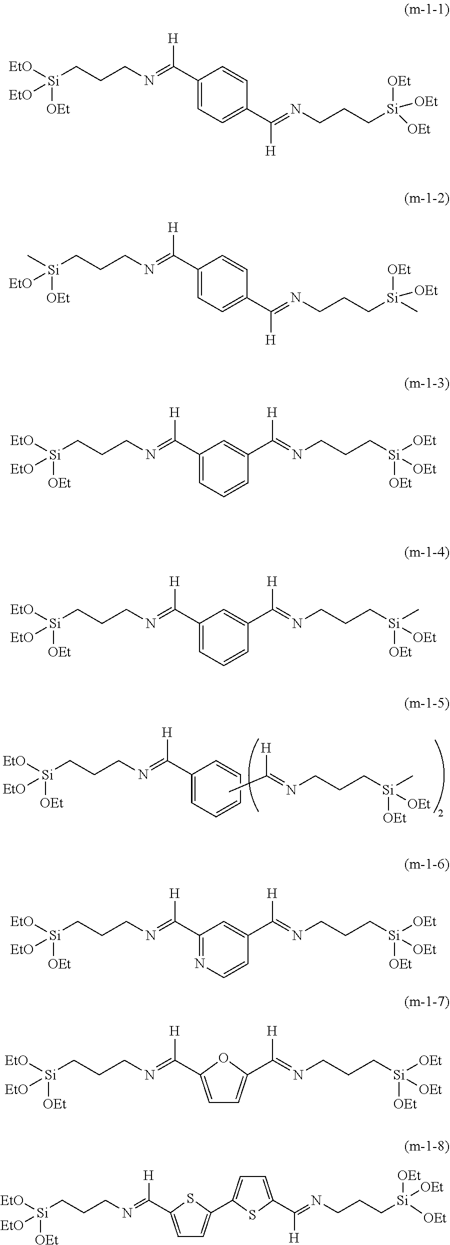

Examples of the compound represented by the formula (9) can include tris(2-triethoxysilylethyl)amine, tris(3-triethoxysilylpropyl) amine, tris(5-triethoxysilylpentyl)amine, N,N,N′,N′-tetra(2-triethoxysilylethyl)-1,2-diaminoethane, N,N,N′,N′-tetra(3-triethoxysilylpropyl)-1,3-diaminopropane and compounds in which an alkyl group and an alkanediyl group in the above-described compound each have been substituted with an alkyl group having 1 to 6 carbon atoms or an alkanediyl group having 1 to 6 carbon atoms. As the terminal modifying agent, one of these may be used singly or two or more of these may be used in combination.

A reaction between the polymerization active terminal and the terminal modifying agent is preferably carried out as a solution reaction. This solution reaction may be carried out using a solution containing an unreacted monomer after the end of the polymerization reaction or may be carried out after the conjugated diene-based polymer having the polymerization active terminal, which is contained in a solution, is isolated and dissolved in an appropriate solvent such as cyclohexane. In addition, the reaction may be carried out using any of a batch type and a continuous type. At this time, a method for adding the terminal modifying agent is not particularly limited, and examples thereof include a method in which the terminal modifying agent is collectively added, a method in which the terminal modifying agent is added in a divided manner, a method in which the terminal modifying agent is continuously added and the like.

Upon the above-described reaction, the amount of the terminal modifying agent used needs to be set as appropriate depending on the kind of the compound that is used in the reaction and is preferably 0.1 molar equivalent or more and more preferably 0.3 molar equivalent or more relative to metal atoms in the polymerization initiator that are involved in the polymerization reaction. When the amount of the terminal modifying agent used upon the above-described reaction is set to 0.1 molar equivalent or more, it is possible to sufficiently progress a modification reaction, to obtain the modified conjugated diene-based polymer (A) containing a sufficient amount of molecules having a modified polymerization terminal and to suitably improve the dispersibility of the filler. In addition, in order to avoid the addition of an excessive amount of the terminal modifying agent, the amount of the terminal modifying agent used is preferably 1.5 molar equivalent or less and more preferably 1.2 molar equivalent or less relative to the metal atoms in the polymerization initiator that are involved in the polymerization reaction.

Upon the above-described reaction, when the amount of the terminal modifying agent used relative to the metal atoms in the polymerization initiator that are involved in the polymerization reaction is adjusted, it is possible to adjust the proportion of modified molecules (modification proportion) in the modified conjugated diene-based polymer (A). The modification proportion is preferably 30 mass % or more, more preferably 50 mass % or more and still more preferably 60 mass % or more relative to the total amount of the modified conjugated diene-based polymer (A).

The temperature of the above-described reaction is normally the same as the temperature of the polymerization reaction, preferably set to −20° C. to 150° C. and more preferably set to 0° C. to 120° C. When the reaction temperature is too low, there is a tendency that the viscosity of the conjugated diene-based polymer after modification increases. On the other hand, when the reaction temperature is too high, the polymerization active terminal is likely to be deactivated. The reaction time is preferably one minute to five hours and more preferably two minutes to one hour.

At the time of producing the modified conjugated diene-based polymer (A), a treatment of reacting the polymerization active terminal and a coupling agent may be carried out for the purpose of increasing the Mooney viscosity or cold flow characteristics of the polymer or the like. A reaction using the coupling agent may be carried out before or after the reaction between the polymerization active terminal and the terminal modifying agent or may be carried out at the same time as the reaction between the polymerization active terminal and the terminal modifying agent. Specific examples of the coupling agent include 2,4-tolylene diisocyanate, diphenylmethane diisocyanate, N,N,N′,N′-tetramethylphthalamide, tetrachlorosilicon, N,N,N′,N′-tetramethyl-4,4′-diaminobenzophenone, tetrachlorotin and the like.

In addition, in the case of using a compound having protective groups (trimethylsilyl groups or the like) as the terminal modifying agent, a polymer obtained by replacing some or all of protective groups with hydrogen in a modified conjugated diene-based polymer having protective groups derived from the terminal modifying agent may be used as the modified conjugated diene-based polymer in the subsequent steps. In addition, in the case of using a protective group-containing compound as the terminal modifying agent, a modified conjugated diene-based polymer modified by the terminal modifying agent and an onium salt generator may be further reacted with each other. In this case, it is possible to obtain a polymer having an onium salt structure in the polymer terminal as the modified conjugated diene-based polymer. When the modified conjugated diene-based polymer has an onium salt structure, it is possible to improve the shape-retaining property of crosslinked products that are obtained using the polymer composition, which is preferable.

The molecular weight distribution (Mw/Mn), which is represented by the ratio of polystyrene-equivalent weight-average molecular weight (Mw) to number-average molecular weight (Mn) measured by gel permeation chromatography (GPC), of the modified conjugated diene-based polymer (A) is 1.50 to 3.00. When Mw/Mn is smaller than 1.50, there is a tendency that the processability at the time of producing a crosslinked product deteriorates. In addition, there is a tendency that the dispersibility of the reinforcing filler, and the rolling resistance (low fuel consumption performance) and tensile characteristics of the crosslinked product are not sufficient. Mw/Mn of the modified conjugated diene-based polymer (A) is preferably 1.55 or more, more preferably 1.60 or more and still more preferably 1.65 or more. In addition, Mw/Mn of the modified conjugated diene-based polymer (A) is 3.00 or less. When Mw/Mn is larger than 3.00, there is a tendency that the low fuel consumption properties of the crosslinked product and the dispersibility of the reinforcing filler deteriorate. Mw/Mn of the modified conjugated diene-based polymer (A) is preferably 2.50 or less, more preferably 2.00 or less and still more preferably 1.95 or less.

The polystyrene-equivalent weight-average molecular weight (Mw) of the modified conjugated diene-based polymer (A) by gel permeation chromatography (GPC) is preferably 1.0×10⁵ or more. When Mw is 1.0×10⁵ or more, there is a tendency that the shape stability, tensile strength and wear resistance of the crosslinked product can be sufficiently enhanced. Mw of the modified conjugated diene-based polymer (A) is more preferably 1.2×10⁵ or more and still more preferably 1.5×10⁵ or more. In addition, Mw of the modified conjugated diene-based polymer (A) is preferably 3.0×10⁶ or less. When Mw is 3.0×10⁶ or less, there is a tendency that the processability of the polymer composition is likely to deteriorate. Mw of the modified conjugated diene-based polymer (A) is more preferably 2.5×10⁶ or less and still more preferably 2.0×10⁶ or less. The weight-average molecular weight (Mw) of the modified conjugated diene-based polymer (A) mentioned herein is a value obtained from all peaks in a GPC curve that is obtained by GPC (total weight-average molecular weight).

The modified conjugated diene-based polymer (A) preferably contains 0.5 mass % or more and 30 mass % or less of a component having a molecular weight of 2.0×10⁶ or more and 5.0×10⁶ or less (hereinafter, also referred to as “specific high-molecular-weight component”) relative to the total amount of the modified conjugated diene-based polymer (A) (100 mass %). This makes it possible to provide crosslinked products having excellent low rolling resistance and tensile characteristics.

The content rate of the specific high-molecular-weight component in the modified conjugated diene-based polymer (A) is more preferably 1.0 mass % or more, still more preferably 1.5 mass % or more and far still more preferably 2.0 mass % or more. In addition, the content rate of the specific high-molecular-weight component in the modified conjugated diene-based polymer (A) is more preferably 28 mass % or less, still more preferably 25 mass % or less and far still more preferably 20 mass % or less from the viewpoint of favorably maintaining the processability of the polymer composition.

Examples of a method for controlling the content rate of the specific high-molecular-weight component include a method in which the molecular weight and molecular weight distribution of the conjugated diene-based polymer before the modification step or before a reaction with a polymerization terminator are controlled, a method in which the coupling rate is controlled and the like. Specifically, in the case of increasing the content rate of the specific high-molecular-weight component, examples thereof include a method in which the amount of the polymerization initiator in the polymerization step is decreased and the molecular weight is increased, a method in which, in the batch type, the feed rate of the polymerization initiator is decreased and the molecular weight distribution is broadened, a method in which the coupling rate is increased by extending the reaction time in the modification step or the like to increase the molecular weight and the like. In a case where a decrease in the content of the specific high-molecular-weight component is desired, it is possible to apply an operation reverse to what has been described above.

### <Component (B): Surfactant>

The present composition contains a surfactant having HLB of 9.0 or less and having a propylene glycol structure (oxypropylene group (—C₃H₆—O—)) (hereinafter, also referred to as “surfactant (B)”).

Here, the surfactant is a compound having a hydrophilic group and a lipophilic group in one molecule. HLB is an acronym for hydrophilic-lipophilic balance and is a value that changes depending on the balance between a hydrophilic group and a lipophilic group in a molecule. HLB represents that the hydrophilicity becomes higher as the numerical value becomes larger. The HLB value in the present specification is a value that is obtained by a calculation formula proposed by Griffin (Griffin method; 20×(the total of the formula weights of hydrophilic portions (an alkyl ether portion and the like) in a surfactant/the molecular weight of the surfactant)). In a case where the surfactant (B) is composed of two or more surfactants, it means that a value obtained from the weighted average of the HLB values of individual components is 9.0 or less.

The HLB value of the surfactant (B) is preferably 8.0 or less, more preferably 7.0 or less, still more preferably 6.7 or less and particularly preferably 6.5 or less since it is possible to obtain a polymer composition for which a performance change has been sufficiently suppressed when the polymer composition is stored for a long period of time, by retaining the surfactant (B) in rubber and stabilizing the rubber. The HLB value of the surfactant (B) is 0 or more. The HLB value of the surfactant (B) is suitably controlled within the above-described range since it is possible to enhance an effect of suppressing the contamination of discharged water that is generated at the time of producing the polymer composition or an effect of improving the transportability of the discharged water and to obtain a polymer composition having physical properties that change less and having high storage stability. In addition, it is possible to obtain a high-performance polymer composition using a water-based solvent at the time of performing desolvation to isolate the polymer composition in a desolvation step to be described below.

The surfactant (B) has an oxypropylene group (—(R⁵⁰—O)ⱼ—, where R⁵⁰ is a propanediyl group and j is an integer of 1 or more) in the molecule. R⁵⁰ may be linear or branched, and examples thereof include a 1,2-propylene group (propane-1,2-diyl group) and a 1,3-propylene group (propane-1,3-diyl group). When the surfactant (B) has the oxypropylene group, it is possible to improve the effect of suppressing the contamination of discharged water that is generated at the time of producing the polymer composition, the transportability of the discharged water or the storage stability of the polymer composition. In addition, it is possible to obtain a high-performance polymer composition using a water-based solvent at the time of isolating the polymer composition in the subsequent desolvation step, which is suitable.

The surfactant (B) is preferably a nonionic surfactant. Specifically, the surfactant (B) is preferably at least one selected from the group consisting of a compound represented by formula (1) and a compound represented by formula (2).

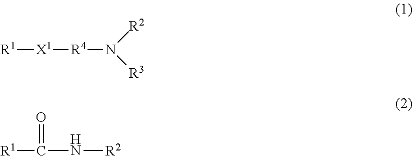

(In the formula (1) and the formula (2), R¹ is a hydrocarbyl group having 10 to 18 carbon atoms, R² is —(R⁶O)ᵣ₁—H, and R³ is a hydrocarbyl group or —(R⁷O)ᵣ₂—H; R⁶ is an ethylene group, a propane-1,2-diyl group or a propane-1,3-diyl group, r1 is an integer of 1 or more, in a case where r1 is 1, R⁶ is a propane-1,2-diyl group or a propane-1,3-diyl group, and in a case where r1 is 2 or more, a plurality of R⁶ is the same as or different from each other, and at least one of the plurality of R⁶ is a propane-1,2-diyl group or a propane-1,3-diyl group; R⁷ is an ethylene group, a propane-1,2-diyl group or a propane-1,3-diyl group, r2 is an integer of 1 or more, and in a case where r2 is 2 or more, a plurality of R⁷ is the same as or different from each other; X¹ is a single bond, an oxygen atom or —NR⁵—; R⁴ is a single bond in a case where X¹ is a single bond, and is a hydrocarbylene group in a case where X¹ is an oxygen atom or —NR⁵—; R⁵ is a hydrogen atom, a hydrocarbyl group or —(R⁸O)ᵣ₃—H; and R⁸ is an ethylene group, a propane-1,2-diyl group or a propane-1,3-diyl group, r3 is an integer of 1 or more, and in a case where r3 is 2 or more, a plurality of R⁸ is the same as or different from each other).

In the formula (1) and the formula (2), R¹ is preferably a saturated or unsaturated linear hydrocarbyl group and more preferably a linear alkyl group or alkenyl group. In a case where R⁴ is a hydrocarbylene group, R⁴ is preferably a saturated or unsaturated linear hydrocarbylene group and more preferably a linear alkanediyl group or alkenediyl group. The number of carbon atoms in each group in one molecule is selected so that HLB reaches 9.0 or less.

As specific examples of the surfactant (B), examples of the compound represented by the formula (1) include polyoxypropylene polyoxyethylene alkylamine, polyoxypropylene alkylamine, polyoxyethylene-alkylpropylene-diamine, polyoxypropylene-alkylpropylene-diamine, 1,1′-(dodecylimino)bis(2-propanol) and the like. Examples of the compound represented by the formula (2) include polyoxypropylene coconut fatty acid monoethanolamide, polyoxypropylene myristate monoethanolamide, polyoxypropylene coconut fatty acid monoisopropanolamide and the like. As the surfactant (B), one surfactant may be used singly or two or more surfactants may be used in combination.

The content proportion of the surfactant (B) in the present composition is preferably 0.05 to 10 parts by mass per 100 parts by mass of the modified conjugated diene-based polymer (A). When the content proportion of the surfactant (B) is within the above-described range, it is possible to sufficiently obtain an effect of suppressing the contamination of discharged water that is generated at the time of producing the polymer composition or an effect of improving the transportability of the discharged water and an effect of improving the storage stability of the polymer composition. From these viewpoints, the content proportion of the surfactant (B) is more preferably 0.1 parts by mass or more and still more preferably 0.2 parts by mass or more per 100 parts by mass of the modified conjugated diene-based polymer (A). In addition, the content proportion of the surfactant (B) is more preferably 9.0 parts by mass or less, still more preferably 8.0 parts by mass or less and far still more preferably 6.0 parts by mass or less per 100 parts by mass of the modified conjugated diene-based polymer (A). As the surfactant (B), one surfactant may be used singly or two or more surfactants may be used in combination.

### <Additional Component>

The polymer composition of the present disclosure may further contain a component different from the modified conjugated diene-based polymer (A) and the surfactant (B) (additional component) as long as the effect of the present disclosure is not impaired. The polymer composition of the present disclosure may contain an extender oil (C) as an optional component.

### (C) Extender Oil

As an oil for oil extension (extender oil), a process oil that is ordinarily used to extend elastomers may be blended with the present composition. A method for adding the process oil is not particularly limited. For example, the process oil may be blended as oil extended rubber by developing the process oil into a polymer solution containing the modified conjugated diene-based polymer (A) after polymerization and then desolvating the process oil. At this time, the process oil may be added before the surfactant (B) is added to the polymer solution or the process oil may be added after the surfactant (B) is added to the polymer solution. It is also possible to directly add the process oil in the middle of kneading for obtaining a rubber compound (blended rubber). As preferable process oils, a variety of oils well known in the industry are exemplified, and examples thereof include aromatic oils, paraffin-based oils, naphthene-based oils, plant oils and oils having a low content of a polycyclic aromatic compound (low PCA oils), for example, mild extraction solvate (MES), treated distillate aromatic extract (TDAE), special residual aromatic extract (SRAE), heavy naphthene-based oil and the like. Examples of commercially available MES, TDAE and SRAE include CATENEX SNR (heavy paraffin obtained by dewaxing a distillate oil with a solvent) manufactured by Shell as MES, VIVATEC 500 manufactured by H & R Wasag AG as TDAE, NC 140 manufactured by Japan Energy Corp. as SRAE and the like.

In the case of blending an extender oil with the present composition, the content proportion of the extender oil in the present composition is preferably 0.05 to 100 parts by mass per 100 parts by mass of the modified conjugated diene-based polymer (A) that is contained in the present composition from the viewpoint of improving processability while suppressing the deterioration of low rolling resistance and strength. The content proportion of the extender oil is more preferably 0.1 parts by mass or more and still more preferably 0.2 parts by mass or more per 100 parts by mass of the modified conjugated diene-based polymer (A). In addition, the content proportion of the extender oil is more preferably 90 parts by mass or less, still more preferably 80 parts by mass or less and far still more preferably 60 parts by mass or less per 100 parts by mass of the modified conjugated diene-based polymer (A).

The present composition is a composition containing the modified conjugated diene-based polymer (A) and the surfactant (B) and further containing the extender oil (C) as an optional component. The extender oil (C) is an optional component, and thus the content of the extender oil (C) in the present composition may be 0 mass %. In the present composition, the total amount of the modified conjugated diene-based polymer (A), the surfactant (B) and the extender oil (C) is 95 mass % or more based on the entire composition. In the present composition, the total amount of the modified conjugated diene-based polymer (A), the surfactant (B) and the extender oil (C) is preferably 97 mass % or more and more preferably 98 mass % or more of the total amount of the present composition. One aspect of the present composition is a solid-form polymer composition from which the solvent has been removed. The present composition may be solid-form particles (crumbs) or may be a rubber bale that is obtained by the compression molding of crumbs into a desired shape (for example, a cuboid shape).

### <<Method for Producing Polymer Composition>>

The present composition is preferably produced by a method including the following mixing step and desolvation step.

Mixing step: A step of mixing a polymer solution dissolving the modified conjugated diene-based polymer (A) in an organic solvent (hereinafter, also referred to as “polymer solution SA”) and the surfactant (B) to obtain a liquid mixture.

Desolvation step: A step of removing the solvent from the liquid mixture obtained by the mixing step (hereinafter, also referred to as “liquid mixture SC”).

In addition, the present composition may also be produced by a method further including the following solution preparation step.

Solution preparation step: A step of obtaining the polymer solution SA.

Hereinafter, each step will be described in detail.

The polymer solution SA in the solution preparation step may be a reaction solution itself containing the modified conjugated diene-based polymer (A), which has been obtained by steps including the above-described polymerization step and modification step or a solution prepared by isolating the modified conjugated diene-based polymer (A) contained in the reaction solution and dissolving the modified conjugated diene-based polymer (A) in an appropriate solvent. Examples of the solvent in which the isolated modified conjugated diene-based polymer (A) is dissolved include the organic solvents exemplified as the solvent that can be used in the polymerization of monomers. At this time, it is preferable to select an organic solvent capable of dissolving the surfactant (B). From the industrial viewpoint, the reaction solution containing the modified conjugated diene-based polymer (A) obtained by the above-described polymerization step or modification step is preferably used as it is as the polymer solution SA since it is possible to reduce the number of steps and to further enhance productivity, and furthermore, the reaction solution containing the modified conjugated diene-based polymer (A) obtained by the above-described modification step is more preferably used as it is as the polymer solution SA since it is possible to further enhance an effect of improving the dispersibility of the reinforcing filler. As the details of the polymerization step and the modification step, the above-descriptions are applied.

The content proportion of the modified conjugated diene-based polymer (A) in the polymer solution SA is preferably 1 mass % or more, more preferably 2 mass % or more and still more preferably 3 mass % or more relative to the total amount of the polymer solution SA. In addition, the content proportion of the modified conjugated diene-based polymer (A) in the polymer solution SA is preferably 90 mass % or less, more preferably 50 mass % or less and still more preferably 30 mass % or less. When the content proportion of the modified conjugated diene-based polymer (A) in the polymer solution SA is set to 1 mass % or more, it is possible to sufficiently ensure the amount of the present composition produced at the time of producing the present composition. In addition, when the content proportion is set to 90 mass % or less, it is possible to uniformly disperse the surfactant (B) in the polymer solution SA and to improve the qualities of a polymer composition to be obtained and the stability thereof.

In the mixing step, the polymer solution SA and the surfactant (B) are mixed, thereby obtaining a liquid mixture SC. A form of mixing the polymer solution SA and the surfactant (B) is not particularly limited. For example, in the case of adding the surfactant (B) to the polymer solution SA, examples thereof include a method in which the surfactant (B) is collectively added to the polymer solution SA, a method in which the surfactant (B) is added to the polymer solution SA in a divided manner, a method in which the surfactant (B) is continuously added to the polymer solution SA and the like. In addition, in the case of adding the surfactant (B) to the polymer solution SA, the surfactant (B) may be added in an undiluted form or the surfactant (B) may be added after the undiluted solution of the surfactant (B) is diluted with an organic solvent capable of dissolving the surfactant (B). After the surfactant (B) is added to the polymer solution SA, it is preferable to uniformly disperse the surfactant (B) in the polymer solution SA by carrying out a treatment such as stirring. The temperature at the time of mixing the polymer solution SA and the surfactant (B) is the same as the temperature of the polymerization reaction, preferably −20° C. to 150° C., more preferably 0° C. to 120° C. and still more preferably 20° C. to 100° C.

The ratio at the time of mixing the polymer solution SA and the surfactant (B) is preferably set so that the blending proportion of the surfactant (B) reaches 0.05 parts by mass or more per 100 parts by mass of the modified conjugated diene-based polymer (A). That is, the blending proportion of the surfactant (B) is preferably 0.05 parts by mass or more, more preferably 0.1 parts by mass or more and still more preferably 0.2 parts by mass or more per 100 parts by mass of the modified conjugated diene-based polymer (A). In addition, the blending proportion of the surfactant (B) is preferably 10 parts by mass or less, more preferably 8 parts by mass or less and still more preferably 5 parts by mass or less per 100 parts by mass of the modified conjugated diene-based polymer (A). When the content proportion of the surfactant (B) is set to 0.05 parts by mass or more, it is possible to sufficiently disperse the surfactant (B) in the polymer solution SA and to sufficiently improve low fuel consumption performance in crosslinked products to be obtained, which is suitable. In addition, when the content proportion of the surfactant (B) is set to 10 parts by mass or less, it is possible to suppress the performance deterioration of the modified conjugated diene-based polymer (A) attributed to the excessive amount of the surfactant (B) contained, which is suitable.

In the desolvation step, the solvent is removed from the liquid mixture SC, and the polymer composition is isolated. A method for removing the solvent from the liquid mixture SC is not particularly limited, and the solvent can be removed by a well-known desolvation method, for example, a method in which the solvent is separated by steam stripping and the obtained polymer composition is dehydrated and dried, a method in which the solvent is devolatilized with a twin screw extruder or the like, a method in which the solvent is directly devolatilized with a drum dryer or the like, or the like. Among these, the solvent is preferably removed by a method in which the liquid mixture SC is brought into contact with water to carry out desolvation since it is possible to simply carry out a desolvation treatment. In the present production method, a surfactant having an HLB value of 9.0 or less and having an oxypropylene group (surfactant (B)) is used as an additive that is mixed with the polymer solution SA in the mixing step. Therefore, in the desolvation step, even in a case where steam stripping is adopted as the desolvation method, it is possible to leave the surfactant (B) in the system and to retain a state in which a sufficient amount of the surfactant (B) and the modified conjugated diene-based polymer (A) are mixed together. This improves the transportability of discharged water that is generated at the time of producing the polymer composition while suppressing the contamination of the discharged water and makes it possible to suppress a change in physical properties caused by the long-term storage of the polymer composition and to sufficiently obtain an effect of improving the low fuel consumption performance of crosslinked products even in a case where steam stripping is adopted, which is suitable.

A step of mixing the extender oil (C) with the polymer solution SA or the liquid mixture SC before the desolvation step may be provided before the desolvation step. A form of mixing the polymer solution SA or the liquid mixture SC and the extender oil (C) is not particularly limited. For example, in the case of adding the extender oil (C) to the polymer solution SA or the liquid mixture SC, examples thereof include a method in which the extender oil (C) is collectively added to the polymer solution SA or the liquid mixture SC, a method in which the extender oil (C) is added to the polymer solution SA or the liquid mixture SC in a divided manner, a method in which the extender oil (C) is continuously added to the polymer solution SA or the liquid mixture SC and the like. After the extender oil (C) is added to the polymer solution SA or the liquid mixture SC, it is preferable to uniformly disperse the extender oil (C) in the polymer solution SA or the liquid mixture SC by carrying out a treatment such as stirring. The temperature at the time of mixing the polymer solution SA or the liquid mixture SC and the extender oil (C) is the same as the temperature of the polymerization reaction, preferably −20° C. to 150° C., more preferably 0° C. to 120° C. and still more preferably 20° C. to 100° C.

The ratio at the time of mixing the polymer solution SA or the liquid mixture SC and the extender oil (C) is preferably set so that the blending proportion of the extender oil (C) reaches 0.05 parts by mass or more per 100 parts by mass of the modified conjugated diene-based polymer (A). That is, the blending proportion of the extender oil (C) is preferably 0.05 parts by mass or more, more preferably 0.1 parts by mass or more and still more preferably 0.2 parts by mass or more per 100 parts by mass of the modified conjugated diene-based polymer (A). In addition, the blending proportion of the extender oil (C) is preferably 100 parts by mass or less, more preferably 90 parts by mass or less and still more preferably 80 parts by mass or less per 100 parts by mass of the modified conjugated diene-based polymer (A). When the blending proportion of the extender oil (C) is set to 0.05 parts by mass or more, it is possible to improve the processability of a polymer composition to be obtained, which is suitable. In addition, when the blending proportion of the extender oil (C) is set to 100 parts by mass or less, it is possible to suppress a decrease in the strengths of crosslinked products to be obtained, which is preferable.

According to the production method including the mixing step and the desolvation step, it is possible to obtain a solid-form polymer composition from which the solvent has been removed. The polymer composition to be obtained is, for example, solid-form particles (crumbs) or is, for example, a rubber bale that is obtained by the compression molding of crumbs into a desired shape (for example, a cuboid shape).

### <<Formulation>>

A formulation of the present disclosure (hereinafter, also referred to as “present formulation”) contains the above-described polymer composition according to the present disclosure and a reinforcing filler (D).

### <Reinforcing Filler (D)>

The reinforcing filler is blended with the present formulation in order to increase the strengths of crosslinked products. Examples of the filler for reinforcement include silica, carbon black, an inorganic compound represented by the following formula (3) (hereinafter, also referred to as “inorganic compound (M)”), fibers for reinforcement (for example, inorganic fibers such as glass fibers or carbon fibers and organic fibers such as nylon or polyesters) and the like. Among these, the reinforcing filler (D) is preferably at least one selected from the group consisting of silica, carbon black and the inorganic compound (M).

nM¹·mSiOₖ·iH₂O (3)

(In the formula (3), M¹ is at least one selected from the group consisting of a specific metal that is any of aluminum, magnesium, titanium and calcium, an oxide of the specific metal, a hydroxide of the specific metal, a hydrate of an oxide of the specific metal and a hydrate of a hydroxide of the specific metal; n is an integer of 1 to 5; m is an integer of 0 to 10; k is an integer of 2 to 5; and i is an integer of 0 to 10).

Examples of the silica include wet silica (hydrous silicic acid), dry silica (silicic anhydride), colloidal silica, precipitated silica, calcium silicate, aluminum silicate and the like. Among these, wet silica is particularly preferable from the viewpoint of an effect of improving fracture characteristics or an effect of satisfying both a wet grip property and low rolling resistance. In addition, high dispersible type silica is also preferably used since it is possible to improve dispersibility in the present formulation and to improve physical properties and processability. As the silica, one kind of silica can be used singly or two or more kinds of silica can be used in combination. Examples of the carbon black include GPF, FEF, HAF, ISAF, SAF and the like, and the carbon black is not particularly limited. Furthermore, in addition to silica or carbon black as the inorganic filler, a variety of reinforcing fillers such as clay and calcium carbonate may be further blended with the polymer composition.

As specific examples of the inorganic compound (M), examples of a compound in which the specific metal is aluminum can include aluminum oxide, alumina monohydrate, aluminum hydroxide, aluminum carbonate, aluminum silicate, calcium aluminum oxide (Al₂O₃·CaO·2SiO₄ and the like) and the like; examples of a compound in which the specific metal is magnesium can include magnesium oxide, magnesium hydroxide, magnesium carbonate, magnesium silicate, magnesium calcium silicate (CaMgSiO₄), talc and the like; examples of a compound in which the specific metal is titanium can include titanium oxide and the like; examples of a compound in which the specific metal is calcium can include calcium oxide, calcium hydroxide, calcium carbonate, calcium silicate and the like, respectively.

As the reinforcing filler (D), one of silica, carbon black and the inorganic compound (M) may be used singly or two or more thereof may be used in combination. Since an effect of improving tire characteristics in the combination with the modified conjugated diene-based polymer (A) is strong, the present formulation preferably contains silica as the reinforcing filler (D), and, particularly, wet silica, dry silica or colloidal silica is preferably used.

The content proportion of the reinforcing filler (D) in the present formulation (the total amount in a case where two or more reinforcing fillers are contained) is preferably 25 to 130 parts by mass and more preferably 30 to 110 parts by mass per 100 parts by mass of the total amount of the polymer components that are contained in the present formulation.

### <Different Component>

The present formulation may further contain components different from the above-described polymer composition of the present disclosure and the reinforcing filler (D) (additional components) as long as the effect of the present disclosure is not impaired. Hereinafter, the additional components that can be contained in the present formulation will be described.

### (C) Extender Oil

As an oil for oil extension (extender oil), a process oil that is ordinarily used to extend elastomers may be blended with the present formulation. A method for adding the process oil is not particularly limited. For example, the process oil may be blended with the present formulation by directly adding the process oil during kneading for obtaining a rubber compound, which is one form of the present formulation. As preferable process oils, a variety of oils well known in the industry are exemplified, and examples thereof include the extender oils exemplified above. The amount of the process oil blended is preferably 0.05 to 100 parts by mass per 100 parts by mass of the total amount of rubber components that are contained in the present formulation.

### (E) Crosslinking Agent

Normally, a crosslinking agent is contained in the present formulation. Examples of the crosslinking agent include sulfur, sulfur halides, organic peroxides, quinonedioximes, organic polyvalent amine compounds, alkylphenol resins having a methylol group and the like, and sulfur is normally used. The amount of sulfur blended is preferably 0.1 to 5 parts by mass and more preferably 0.5 to 3 parts by mass per 100 parts by mass of the total amount of rubber components that are contained in the present formulation.

### (F) Different Rubber Component

A rubber component different from the modified conjugated diene-based polymer (A) (hereinafter, also referred to as “additional rubber component”) may be further blended with the present formulation. “Rubber component” in the present specification refers to a polymer from which a cured product exhibiting rubber elasticity by thermal curing can be obtained. The cured product exhibits properties of significantly deforming due to a small force at room temperature (for example, deforming to stretch twice or more when stretched at room temperature) and rapidly returning to an almost original shape when the force is removed.

The kind of the additional rubber component is not particularly limited, but unmodified rubber is preferable and examples thereof include butadiene rubber (BR, for example, high-cis BR in which cis-1,4 bonds account for 90% or more), styrene butadiene rubber (SBR), natural rubber (NR), isoprene rubber (IR), styrene isoprene copolymer rubber, butadiene isoprene copolymer rubber and the like. The amount of the additional rubber component blended is preferably 5 to 60 parts by mass and more preferably 10 to 50 parts by mass per 100 parts by mass of the total amount of the rubber components that are contained in the present formulation (the modified conjugated diene-based polymer (A) and the additional rubber component). In the present specification, the modified conjugated diene-based polymer (A) and the additional rubber component will also be collectively referred to simply as “polymer components”.

In addition to the above-described components, a variety of additives that are ordinarily used in formulations that are used to produce crosslinked products such as tires, for example, an antiaging agent, zinc white, stearic acid, a softening agent, sulfur, a vulcanization accelerator, a silane coupling agent, a compatibilizer, a vulcanization aid, a processing aid, an anti-scorch agent and the like can be blended with the present formulation. The amount of these blended can be selected as appropriate depending on a variety of components to an extent that the effect of the present disclosure is not impaired.

The present formulation can be obtained by blending a variety of the above-described components (the components (C) to (F) or a variety of additives and the like that are ordinarily used in formulations that are used to produce crosslinked products such as tires) as necessary with the polymer composition of the present disclosure. The present formulation can be obtained by mixing a variety of additives that are arbitrarily used in formulations for obtaining crosslinked products (that is, vulcanized rubber) with the polymer composition of the present disclosure and kneading the components using a kneader such as an open kneader (for example, a roll) or a closed kneader (for example, a Banbury mixer).

### <<Method for Producing Crosslinked Product>>

A crosslinked product (that is, vulcanized rubber) can be obtained by molding and then crosslinking (vulcanizing) the formulation obtained above.

The vulcanized rubber is preferably obtained by, for example, a method including the following kneading step. In the kneading step, first, the above-described polymer composition (that is, the present composition) and an additive other than vulcanization compounding agents (a crosslinking agent, a vulcanization accelerator and a vulcanization aid) (hereinafter, also referred to as “first additive”) are melted and kneaded using a kneader (first step). The first additive preferably contains at least the reinforcing filler (D). The first additive may further contain a surfactant to an extent that the effect of the present disclosure is not impaired. Specifically, the content of the surfactant in the first additive is preferably 10 parts by mass or less, more preferably 5 parts by mass or less and still more preferably 1 parts by mass or less per 100 parts by mass of the surfactant that is used in the mixing step. The kneading temperature in the first step is set as appropriate depending on the melting points, glass transition temperatures or the like of the polymer components. This melting and kneading makes the first additive mixed with the polymer components and makes it possible to sufficiently obtain an effect of increasing the strength of a rubber product after vulcanization, improving the kneading processability of the polymer composition, preventing the deterioration of rubber attributed to a radical generated during kneading or the like.

Subsequently, a kneaded product obtained by the first step is returned to room temperature as necessary, then, the vulcanization compounding agents are added to the kneaded product, and the components are melted and kneaded using the kneader (second step). A blended product obtained by the second step is molded and then crosslinked (vulcanized), whereby a crosslinked product can be obtained.

### <<Crosslinked Product and Tire>>

The crosslinked product that is obtained using the present composition can be applied to a variety of rubber products. Specific examples of the variety of rubber products include tire uses such as tire treads, undertreads, carcasses, sidewalls and beads; sealing materials such as packings, gaskets, weather strips and O-rings; interior and exterior skin materials for a variety of vehicles such as automobiles, ships, aircrafts and railways; building materials; anti-vibration rubbers for industrial machinery and facilities and the like; a variety of hoses and hose covers such as diaphragms, rolls, radiator hoses and air hoses; belts such as belts for power transmission; linings; dust boots; medical equipment materials; fenders; insulating materials for electric wires; other industrial products and the like.

According to the present composition, it is possible to obtain a crosslinked product having small rolling resistance and excellent low fuel consumption performance. Therefore, the present composition is suitable as a material for, in particular, either or both of a tread and a sidewall of a tire.

A tire can be produced according to a normal method. For example, a mixture containing the polymer composition of the present disclosure and a component that is blended as necessary (the formulation of the present disclosure) is mixed with a kneader and made into a sheet shape, the sheet-shaped mixture is disposed at a predetermined position according to a normal method and vulcanization-molded to form a tread rubber, a sidewall rubber or both, and a pneumatic tire is obtained.

### EXAMPLES

Hereinafter, the present disclosure will be specifically described based on examples, but the present disclosure is not limited to these examples. “Parts” and “%” in the following synthesis examples, examples and comparative examples are mass-based unless particularly otherwise described. Methods for measuring a variety of physical property values of a polymer and a polymer composition P (polymer composition before a reinforcing filler is blended) will be described below.
Bound styrene content (%): Calculated by ¹H-NMR measurement at 400 MHz using deuterated chloroform as a solvent.
Vinyl group content (%): Calculated by ¹H-NMR measurement at 400 MHz
Weight-average molecular weight and molecular weight distribution of polymer and proportion of component having molecular weight of 2.0×10⁶ or more and 5.0×10⁶ or less: Obtained based on a chart obtained based on the polystyrene-equivalent molecular weight obtained by gel permeation chromatography (GPC) (GPC curve). Specific measurement conditions of GPC are as described below.

### (GPC Measurement Conditions)

Measuring instrument: HLC-8020 (manufactured by Tosoh Corporation)

Column: Two GMH-HR-H (manufactured by Tosoh Corporation) were linked in series

Detector: Differential refractometer RI-8020 (manufactured by Tosoh Corporation)

Eluent: Tetrahydrofuran

Column temperature: 40° C.

Flow rate: 1.0 ml/minute

Sample concentration: 10 mg/20 ml
Mooney viscosity (ML1+4, 125° C.) and Mooney stress-relaxation rate (MSR, ML1+4, 125° C.): Measured from a polymer composition P to be described below as a measurement specimen using a Mooney tester (manufactured by Alpha Technologies). According to JIS K 6300 (ISO 289-1) and ISO 289-4, first, the specimen was preheated for one minute under a temperature condition of 125° C. and then rotated at 2 rpm with a rotor, the torque was measured after four minutes, and the measured value was regarded as the Mooney viscosity (ML(1+4)). After that, the rotation of the rotor was stopped immediately, the torque was recorded in the Mooney unit every 0.1 seconds during 1.4 to six seconds from the stoppage, the slope of a straight line in a log-log plot of the torque and the time (seconds) was obtained, and the absolute value thereof was regarded as the Mooney stress-relaxation rate. It is indicated that, as the value of the Mooney viscosity decreases, the processability of the polymer composition becomes more favorable. MV measured from each polymer composition P immediately after being dried with a heated roll as a measurement specimen was regarded as “MV immediately after production”. “MV after 50 days from production” was measured in the same manner from each polymer composition P stored at 25° C. for 50 days after being dried with a heated roll as a measurement specimen.
COD of desolvated water (Mn, mg/L): A liquid component (a liquid containing water as a main component) in a mixture obtained according to conditions shown in “Desolvation Conditions” to be described below was used as a measurement specimen, according to JIS K 0102-17. “chemical oxygen demand by potassium permanganate at 100° C. (CODM)”, an appropriate amount of the measurement specimen was fed into a 300 mL Erlenmeyer flask, and distilled water was added thereto until the volume reached 100 mL. Sulfuric acid (1+2) was added to this solution, and silver sulfate as a sulfate acidic reagent and potassium permanganate as an oxidant were added thereto. This solution was reacted for 30 minutes in a boiling water bath, and the amount of permanganate consumed at this time was obtained and represented by the equivalent amount (mg/L) of oxygen. The measurement was carried out three times, and the arithmetic average value thereof was recorded. It is indicated that, as the value decreases, the degree of contamination of discharged water decreases.
Remaining bubble height of desolvated water (cm): The liquid component (the liquid containing water as a main component) in the mixture obtained according to conditions shown in “Desolvation Conditions” to be described below was used as a measurement specimen and, according to Japanese Pharmacopoeia test, approximately 5 mL of the measurement specimen was fed into a graduated cylinder with a stopper. After the graduated cylinder was closed with the stopper, the measurement specimen was intensely shaken for three minutes. In a case where bubbles did not disappear even after the measurement specimen was placed still for five minutes or longer, the thickness of a bubble layer was measured and recorded. In a case where bubbles were not generated even after the measurement specimen was intensely shaken, “0” was given as the value. The remaining bubble height of desolvated water is also an index of “the transportability of discharged water.” It is indicated that, as the value of the thickness of the bubble layer decreases, the defoaming property becomes more favorable and the transportability of discharged water increases. The measurement was carried out three times, and the arithmetic average value thereof was recorded.

### 1. Synthesis of (Modified) Conjugated Diene-Based Polymer and Production of Polymer Composition P

### EXAMPLE 1: SYNTHESIS OF MODIFIED CONJUGATED DIENE-BASED POLYMER AL AND PRODUCTION OF POLYMER COMPOSITION P1

1,3-Butadiene and styrene as monomers, cyclohexane as a solvent, tetrahydrofuran as a vinyl group content adjuster (randomizer) and n-butyllithium as a polymerization initiator were continuously charged into a nitrogen-substituted autoclave reactor having an inner capacity of 50 liters (first reactor) at rates of 83.4 g/minute, 27.8 g/minute, 745.3 g/minute, 1.2 g/minute and 54.2 mg/minute, respectively, and the temperature in the reactor was controlled at 75° C.

A polymer solution was continuously discharged from the first reactor at a rate of 857.9 g/minute, a compound represented by the following formula N—Si-1 was added to the discharged polymer solution at a rate of 113.0 mg/minute, the polymer solution was continuously introduced into a second reactor and a reaction was carried out. di-tert-Butyl-p-cresol was added at the outlet of the second reactor so that the content thereof reached 0.88 parts by mass per 100 parts by mass of a polymer. To a polymer solution SA1 containing a modified conjugated diene-based polymer A1 produced as described above, an extender oil (process oil T-DAE manufactured by ENEOS Corporation) and a surfactant a-1 (nonionic surfactant manufactured by Lion Specialty Chemicals Co., Ltd., LIPONOL C18/18, polyoxypropylene polyoxyethylene coconut alkyl (C8-C18) amine, HLB=6.4) were added at rates of 27.8 g/minute and 3.3 g/minute, respectively, thereby obtaining a liquid mixture SC1. Next, desolvation was carried out on the liquid mixture SC1 under conditions shown in the following “Desolvation Conditions”, thereby obtaining a rubber-form substance. The rubber-form substance was dried with a heated roll having a temperature adjusted to 110° C., and a polymer composition P1 containing the modified conjugated diene-based based polymer A1, the surfactant a-1 and the extender oil was obtained.

### Desolvation Conditions

The liquid mixture SC1 (200 g) and deionized water (300 g) were injected into a pressure vessel, and desolvation was carried out for 60 minutes by steam stripping (steam temperature: 190° C.)

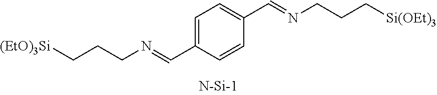

A variety of physical property values and the like of the modified conjugated diene-based polymer A1 and the polymer composition P1 are shown in Table 1. The physical properties of the modified conjugated diene-based polymer A1 are the measurement results from a polymer obtained by extracting part of the polymer solution SA1 to the outside of the polymerization line and carrying out desolvation for 24 hours under conditions of 60° C. and 0.1 mmHg as a measurement specimen. “-” in Table 1 indicates that the corresponding compound is not added.

### EXAMPLES 2, 3, 7 and 8 and COMPARATIVE EXAMPLES 2 to 5

Polymerization, desolvation and drying were carried out in the same manner as in Example 1 except that the kind of the surfactant used was changed as shown in Table 1, thereby obtaining polymer compositions P2, P3, P7, P8 and P10 to P13. A variety of physical property values and the like of the obtained polymer compositions P2, P3, P7, P8 and P10 to P13 are shown in Table 1. The term “(modified) conjugated diene-based polymer” is a collective term for a modified conjugated diene-based polymer and an unmodified conjugated diene-based polymer.

### EXAMPLE 4

Polymerization, desolvation and drying were carried out in the same manner as in Example 1 except that the extender oil was not added to the polymer solution SA1 containing the modified conjugated diene-based polymer A1, thereby obtaining a polymer composition P4. A variety of physical property values and the like of the obtained polymer composition P4 are shown in Table 1.

### EXAMPLES 5 and 6

Polymerization, desolvation and drying were carried out in the same manner as in Example 4 except that the kind of the surfactant used was changed as shown in Table 1, thereby obtaining polymer compositions P5 and P6. A variety of physical property values and the like of the obtained polymer compositions P5 and P6 are shown in Table 1.

### Comparative Example 1

Polymerization, desolvation and drying were carried out in the same manner as in Example 1 except that a terminal modifying agent was not added at the time of polymerization, thereby obtaining a polymer composition P9. A variety of physical property values and the like of an obtained conjugated diene-based polymer and the polymer composition P9 are shown in Table 1. The conjugated diene-based polymer synthesized in Comparative Example 1 is an unmodified conjugated diene-based polymer.

### Comparative Example 6

Cyclohexane (2,500 g), tetrahydrofuran (50 g), styrene (125 g) and 1,3-butadiene (365 g) were prepared in a nitrogen-substituted autoclave reactor having an internal capacity of five liters. The temperature of the contents in the reactor was adjusted to 10° C., and then n-butyllithium (5.2 mmol) was added thereto to initiate polymerization. The polymerization was carried out under an adiabatic condition, and the peak temperature reached 85° C. At a point in time where the polymerization conversion rate reached 99% (after 26 minutes from the initiation of the polymerization), 1.3-butadiene (10 g) was added thereto for two minutes, polymerization was further carried out for three minutes, and then N—Si-2(N,N-bis(trimethylsilyl)aminopropylmethyldiethoxysilane) (4.5 mmol) was added thereto to carry out a reaction for 15 minutes, thereby obtaining a modified conjugated diene-based polymer solution.

Pentaerythritol tetrakis[3-(3,5-di-tert-butyl-4-hydroxyphenyl)propionate] was added to the obtained modified conjugated diene-based polymer solution, next, a surfactant a-1 (nonionic surfactant manufactured by Lion Specialty Chemicals Co., Ltd., LIPONOL C18/18, polyoxypropylene polyoxyethylene coconut alkyl (C8-C18) amine, HLB=6.4) (2.5 g) was added to this modified conjugated diene-based polymer solution and mixed. Next, desolvation was carried out under conditions shown in the above-described “Desolvation Conditions”, and the modified conjugated diene-based polymer solution was dried with a heated roll having a temperature adjusted to 110° C., thereby obtaining a polymer composition P14. A variety of physical property values of the polymer composition P14 are shown in Table 1 below.

TABLE 1

| | | Exam- | Exam- | Exam- | Exam- | Exam- | Exam- |
|---|---|---|---|---|---|---|---|
| | | ple 1 | ple 2 | ple 3 | ple 4 | ple 5 | ple 6 |
| <Production of (Modified) Conjugated Diene-Based Polymer> | | | | | | | |
| Solvent | Cyclohexane (g/min) | 745.3 | 745.3 | 745.3 | 745.3 | 745.3 | 745.3 |
| Vinyl group content adjuster | Tetrahydrofuran (g/min) | 1.2 | 1.2 | 1.2 | 1.2 | 1.2 | 1.2 |
| Monomer | Styrene (g/min) | 27.8 | 27.8 | 27.8 | 27.8 | 27.9 | 27.8 |
| | 1,3-Butadiene (g/min) | 83.4 | 83.4 | 83.4 | 83.4 | 83.4 | 83.4 |
| Polymerization initiator | n-Butyllithium (mg/min) | 54.2 | 54.2 | 54.2 | 54.2 | 54.2 | 54.2 |
| Terminal modifying agent | N—S: −1 (*1) (mg/min) | 113.0 | 113.0 | 113.0 | 113.0 | 113.0 | 113.0 |
| | N—S: −2 (*2) (mmol) | — | — | — | — | | — |
| Physical properties of | Bound styrene content (%) | 25 | 25 | 25 | 25 | 25 | 25 |
| (modified) conjugated diene- | Vinyl group content (%) | 25 | 25 | 25 | 25 | 25 | 25 |
| based polymer | Weight-average molecular weight | 85.7 | 85.7 | 85.7 | 85.7 | 85.7 | 85.7 |
| | after modification (×10⁴) | | | | | | |
| | Molecular weight distribution | 1.86 | 1.86 | 1.86 | 1.86 | 1.85 | 1.86 |
| | after modification (Mw/Mn) | | | | | | |
| | Component having a molecular weight of | 6.9 | 6.9 | 5.9 | 6.9 | 6.9 | 6.9 |
| | 2.0 × 10⁶ or more and 5.0 × 10⁶ or | | | | | | |
| | less after modification (wt %) | | | | | | |
| <Production of Polymer Composition P> | | | | | | | |
| Name of polymer composition P | | P1 | P2 | P3 | P4 | P5 | P6 |
| Extender oil | Addition amount (g/min) | 27.8 | 27.8 | 27.8 | — | — | — |
| Surfactant | Type | a-1 | a-2 | a-3 | a-1 | a-2 | a-3 |
| | Addition amount (g/min) | 3.3 | 3.3 | 3.3 | 3.3 | 3.3 | 3.3 |
| | HLB | 6.4 | 0.0 | 9.0 | 6.4 | 0.0 | 9.0 |
| Components of polymer | (A) Conjugated diene-based | 100.0 | 100.0 | 100.0 | 100.0 | 100.0 | 100.0 |
| composition | polymer (parts by mass) | | | | | | |
| | Conjugated diene-based polymer | — | — | — | — | — | — |
| | (unmodified) (parts by mass) | | | | | | |
| | (B) Surfactant (parts by mass) | 3.0 | 3.0 | 3.0 | 3.0 | 3.0 | 3.0 |
| | (C) Extender oil (parts by mass) | 25.0 | 25.0 | 25.0 | 0.0 | 0.0 | 0.0 |
| | Antiaging agent *4) (parts by mass) | 0.88 | 0.88 | 0.88 | 0.88 | 0.88 | 0.88 |
| | Ratio of the total amount of (A), | 99.3 | 99.3 | 99.3 | 99.2 | 99.2 | 99.2 |
| | (B) and (C) in the polymer | | | | | | |
| | composition (wt %) | | | | | | |
| Physical properties of | MV (ML1 − 4, 125° C.) | 76 | 72 | 76 | 120 | 118 | 120 |
| polymer composition | MV stress-relaxation rate (MSR, | 0.35 | 0.38 | 0.36 | 0.23 | 0.23 | 0.22 |
| | ML1 + 4, 125° C.) | | | | | | |
| | MV after 50 days from production | 86 | 78 | 86 | 127 | 123 | 128 |
| | (ML1 + 4, 125° C.) | | | | | | |
| | MV amount of change (MV after 50 | 10 | 6 | 10 | 7 | 5 | 8 |
| | days from production − MV | | | | | | |
| | immediately after production) | | | | | | |
| | COD in desolvated water (Mn, | 56 | <10 | 60 | 53 | <10 | 60 |
| | mg/L) *5) | | | | | | |
| | Remaining bubble height of | 3.8 | 0 | 3.1 | 4 | 0 | 2.8 |
| | desolvated water (cm) *5) | | | | | | |

| | | | | Compar- | Compar- | Compar- |
|---|---|---|---|---|---|---|
| | | | | ative | ative | ative |
| | | Exam- | Exam- | Exam- | Exam- | Exam- |
| | | ple 7 | ple 8 | ple 1 | ple 2 | ple 3 |
| <Production of (Modified) Conjugated Diene-Based Polymer> | | | | | | |
| Solvent | Cyclohexane (g/min) | 745.3 | 745.3 | 745.3 | 745.3 | 745.3 |
| Vinyl group content adjuster | Tetrahydrofuran (g/min) | 1.2 | 1.2 | 1.2 | 1.2 | 1.2 |
| Monomer | Styrene (g/min) | 27.8 | 27.8 | 27.8 | 27.8 | 27.8 |
| | 1,3-Butadiene (g/min) | 83.4 | 83.4 | 83.4 | 83.4 | 83.4 |
| Polymerization initiator | n-Butyllithium (mg/min) | 54.2 | 54.2 | 54.2 | 54.2 | 54.2 |
| Terminal modifying agent | N—S: −1 (*1) (mg/min) | 113.0 | 113.0 | — | 113.0 | 113.0 |
| | N—S: −2 (*2) (mmol) | — | — | — | — | — |
| Physical properties of | Bound styrene content (%) | 25 | 25 | 25 | 25 | 25 |
| (modified) conjugated diene- | Vinyl group content (%) | 25 | 25 | 25 | 25 | 25 |
| based polymer | Weight-average molecular weight | 85.7 | 85.7 | — | 85.7 | 85.7 |
| | after modification (×10⁴) | | | | | |
| | Molecular weight distribution | 1.86 | 1.86 | — | 1.86 | 1.86 |
| | after modification (Mw/Mn) | | | | | |
| | Component having a molecular weight of | 6.9 | 6.9 | — | 6.9 | 6.9 |
| | 2.0 × 10⁶ or more and 5.0 × 10⁶ or | | | | | |
| | less after modification (wt %) | | | | | |
| <Production of Polymer Composition P> | | | | | | |
| Name of polymer composition P | | P7 | P8 | P9 | P10 | P11 |
| Extender oil | Addition amount (g/min) | 27.8 | 27.8 | 27.8 | 27.8 | 27.8 |
| Surfactant | Type | a-1 | a-2 | a-2 | — | a-4 |
| | Addition amount (g/min) | 0.6 | 6.7 | 3.3 | — | 3.3 |
| | HLB | 6.4 | 0.0 | 0.0 | — | 6.5 |
| Components of polymer | (A) Conjugated diene-based | 100.0 | 100.0 | — | 100.0 | 100.0 |
| composition | polymer (parts by mass) | | | | | |
| | Conjugated diene-based polymer | — | — | 100.0 | — | — |
| | (unmodified) (parts by mass) | | | | | |
| | (B) Surfactant (parts by mass) | 0.5 | 6.0 | 3.0 | 0.0 | 3.0 |
| | (C) Extender oil (parts by mass) | 25.0 | 25.0 | 25.0 | 25.0 | 25.0 |
| | Antiaging agent *4) (parts by mass) | 0.88 | 0.88 | 0.88 | 0.88 | 0.88 |
| | Ratio of the total amount of (A), | 99.3 | 99.3 | — | 99.3 | 99.3 |
| | (B) and (C) in the polymer | | | | | |
| | composition (wt %) | | | | | |
| Physical properties of | MV (ML1 − 4, 125° C.) | 75 | 68 | 25 | 77 | 76 |
| polymer composition | MV stress-relaxation rate (MSR, | 0.35 | 0.40 | 0.57 | 0.34 | 0.36 |
| | ML1 + 4, 125° C.) | | | | | |
| | MV after 50 days from production | 90 | 70 | 27 | 98 | 97 |
| | (ML1 + 4, 125° C.) | | | | | |
| | MV amount of change (MV after 50 | 15 | 2 | 2 | 21 | 21 |
| | days from production − MV | | | | | |
| | immediately after production) | | | | | |
| | COD in desolvated water (Mn, | <10 | <10 | <10 | <10 | 120 |
| | mg/L) *5) | | | | | |
| | Remaining bubble height of | 0 | 0 | 0 | 0 | 6.1 |
| | desolvated water (cm) *5) | | | | | |

| | | Compar- | Compar- | Compar- | |
|---|---|---|---|---|---|
| | | ative | ative | ative | |
| | | Exam- | Exam- | Exam- | |
| | | ple 4 | ple 5 | ple 6 *3) | |
| <Production of (Modified) Conjugated Diene-Based Polymer> | | | | | |
| Solvent | Cyclohexane (g/min) | 745.3 | 745.3 | 2500 | g |
| Vinyl group content adjuster | Tetrahydrofuran (g/min) | 1.2 | 1.2 | 50 | g |
| Monomer | Styrene (g/min) | 27.8 | 27.8 | 125 | g |
| | 1,3-Butadiene (g/min) | 83.4 | 83.4 | 365 g/10 g | |
| Polymerization initiator | n-Butyllithium (mg/min) | 54.2 | 54.2 | 5.2 | mmol |

| Terminal modifying agent | N—S: −1 (*1) (mg/min) | 113.0 | 113.0 | — |
|---|---|---|---|---|
| | N—S: −2 (*2) (mmol) | — | — | 4.5 |
| Physical properties of | Bound styrene content (%) | 25 | 25 | 25 |
| (modified) conjugated diene- | Vinyl group content (%) | 25 | 25 | 55 |
| based polymer | Weight-average molecular weight | 85.7 | 85.7 | 21.0 |
| | after modification (×10⁴) | | | |
| | Molecular weight distribution | 1.86 | 1.86 | 1.10 |
| | after modification (Mw/Mn) | | | |
| | Component having a molecular weight of | 6.9 | 6.9 | 0 |
| | 2.0 × 10⁶ or more and 5.0 × 10⁶ or | | | |
| | less after modification (wt %) | | | |
| <Production of Polymer Composition P> | | | | |
| Name of polymer composition P | | P12 | P13 | P14 |
| Extender oil | Addition amount (g/min) | 27.8 | 27.8 | — |
| Surfactant | Type | a-5 | a-6 | a-1 |

| | | | | |
|---|---|---|---|---|
| Addition amount (g/min) | 3.3 | 3.3 | 2.5 | g |

| | | | | |
|---|---|---|---|---|
| | HLB | 12.5 | 14.0 | 6.4 |
| Components of polymer | (A) Conjugated diene-based | 100.0 | 100.0 | 100.0 |
| composition | polymer (parts by mass) | | | |
| | Conjugated diene-based polymer | — | — | — |
| | (unmodified) (parts by mass) | | | |
| | (B) Surfactant (parts by mass) | 3.0 | 3.0 | 0.5 |
| | (C) Extender oil (parts by mass) | 25.0 | 25.0 | 0.0 |
| | Antiaging agent *4) (parts by mass) | 0.88 | 0.88 | 0.88 |
| | Ratio of the total amount of (A), | 99.3 | 99.3 | 99.1 |
| | (B) and (C) in the polymer | | | |
| | composition (wt %) | | | |
| Physical properties of | MV (ML1 − 4, 125° C.) | 77 | 75 | 35 |
| polymer composition | MV stress-relaxation rate (MSR, | 0.36 | 0.36 | 0.54 |
| | ML1 + 4, 125° C.) | | | |
| | MV after 50 days from production | 100 | 102 | 50 |
| | (ML1 + 4, 125° C.) | | | |
| | MV amount of change (MV after 50 | 23 | 27 | 15 |
| | days from production − MV | | | |
| | immediately after production) | | | |
| | COD in desolvated water (Mn, | 163 | 210 | 58 |
| | mg/L) *5) | | | |
| | Remaining bubble height of | 8.2 | 10.8 | 3.6 |
| | desolvated water (cm) *5) | | | |

*3) The addition amount of compounds indicates the amount of input in the batch polymerization.
*4) Examples 1 to 8 and Comparative Examples 1 to 5 used 2,6-di-tert-buthyl-p-cresol, and Comparative Example 6 used pentaerythritol tetrakis [3-(3,5-di-tert-butyl-4-hydroxyphenyl)propionate].
*5) The arithmetic average value of the measurements of three times was recorded.
Abbreviations in Table 1 are as described below. (Terminal Modifying Agent)
N—Si-1 (*1): A compound represented by the formula N—Si-1.
N—Si-2 (*2): N,N-bis(trimethylsilyl)aminopropylmethyldiethoxysilane (Surfactant)
a-1: LIPONOL C18/18 (nonionic surfactant manufactured by Lion Specialty Chemicals Co., Ltd., polyoxypropylene polyoxyethylene coconut alkyl (C8-C18) amine, HLB = 6.4)
a-2: FT-6020J (nonionic surfactant manufactured by Lion Specialty Chemicals Co., Ltd., polyoxypropylene alkyl (C8-C18) amine, HLB = 0.0)
a-3: AMIZETT 1PC (nonionic surfactant manufactured by Kawaken Fine Chemicals Co., Ltd., polyoxypropylene coconut fatty acid monoisopropanolamide, HLB = 9.0)
a-4: LEOSTAT GS-95P (nonionic surfactant manufactured by Lion Specialty Chemicals Co., Ltd., glycerin monostearate, HLB = 6.5)
a-5: NYMEEN S-210 (nonionic surfactant manufactured by NOF Corporation, polyoxyethylene stearyl amine, HLB = 12.5)
a-6: LIPONOL T/25 (nonionic surfactant manufactured by Lion Specialty Chemicals Co., Ltd., polyoxyethylene alkyl amine, HLB = 14.0)

The HLB values of the surfactants are values calculated by the Griffin method.

### 2. Production of Formulation Q

### EXAMPLES 9 to 16 and COMPARATIVE EXAMPLES 7 to 13

Individual components were blended according to blending formulae shown in Table 2 below and melted and kneaded to produce formulations Q. The kneading was carried out by the following method.

As first-stage kneading, the polymer composition P, polybutadiene rubber, an extender oil, silica, a silane coupling agent, stearic acid, an antiaging agent and zinc oxide were blended and kneaded using a batch-type mixer equipped with a temperature control device (manufactured by Toyo Seiki Seisaku-sho Co., Ltd.; trade name LABO PLASTOMILL) at a set temperature adjusted to 100° C. under conditions of a rotation speed of 60 rpm and a kneading time of four minutes. In Comparative Example 13, a surfactant was further blended. The temperatures of kneaded products discharged from the mixer at the time of the discharge were all approximately 150° C.

Next, as second-stage kneading, the kneaded products obtained by the first-stage kneading were cooled to room temperature, then, a vulcanization accelerator and sulfur were blended therewith in the mixer, the set temperature was adjusted to 70° C. and the components were kneaded under conditions of a rotation speed of 60 rpm and a kneading time of 1.5 minutes, thereby obtaining formulations Q (Q1 to Q15), respectively. The temperatures of kneaded products discharged from the mixer at the time of the discharge were all 100° C. or lower. Next, vulcanization molding was carried out on the individual obtained formulations Q with a vulcanization press at 160° C. for a predetermined time, thereby obtaining crosslinked rubbers as crosslinked products. Physical properties were evaluated as described below using the obtained crosslinked rubbers. The results are shown in Table 2 below. “-” in Table 2 indicates that the corresponding component is not added.

### Mooney Viscosity (MV)

The kneaded products before vulcanization were used as measurement specimens, and, according to JIS K 6300-1: 2013, the Mooney viscosities were measured under conditions of one minute of preheating, four minutes of rotor operation time and a temperature of 100° C. using a Mooney tester (manufactured by Alpha Technologies) and an L rotor. The Mooney viscosity of Comparative Example 8 is regarded as 100 as an index, and it is indicated that, as the numerical value becomes larger, the processability of the formulation becomes more favorable.

### Loss Tangent (3% tan δ at 50° C. Rolling Resistance)

The crosslinked rubbers were used as measurement specimens, and the ratios of the loss modulus G″ to the storage modulus G′ under a condition of a shear strain of 3% (50° C. tan δ) were measured using a shear-type dynamic spectrometer (manufactured by TA Instruments Japan Inc.) under conditions of an angular velocity of 100 radians per second and a temperature of 50° C. The ratio of Comparative Example 8 is regarded as 100 as an index, and it is indicated that, as the numerical value becomes larger, the rolling resistance becomes smaller, and the low fuel consumption performance becomes more favorable.

### Filler Dispersibility (Δtan δ)

The crosslinked rubbers were used as measurement specimens, the elastic moduli at a dynamic shear strain of 0.1% and the elastic moduli at a dynamic shear strain of 10.0% were measured using an ARES viscoelasticity tester (manufactured by TA Instruments Japan Inc.) under conditions of an angular velocity of 100 radians per second and 50° C., and the absolute values of the differences thereof were calculated as Δtan δ. The absolute value of Comparative Example 8 is regarded as 100 as an index, and it is indicated that, as the numerical value becomes larger, the dispersibility of the filler becomes more favorable.

### Tensile Strength (M300)

The crosslinked rubbers were used as measurement specimens, and 300% moduli (M300) were measured according to JIS K 6251: 2010. Regarding the measurement results, the 300% modulus of Comparative Example 8 is regarded as 100 as an index, and it is indicated that, as the numerical value becomes larger, the tensile strength increases and becomes more favorable.

TABLE 2

| | | | | | | | | | | | Compar- |
|---|---|---|---|---|---|---|---|---|---|---|---|
| | | | | | | | | | | | ative |
| | | | Exam- | Exam- | Exam- | Exam- | Exam- | Exam- | Exam- | Exam- | Exam- |
| <Production of Formulation Q> | | | ple 9 | ple 10 | ple 11 | ple 12 | ple 13 | ple 14 | ple 15 | ple 16 | ple 7 |
| Name of formulation Q | | | Q1 | Q2 | Q3 | Q4 | Q5 | Q6 | Q7 | Q8 | Q9 |
| First-stage | Polymer composition P | type | P1 | P2 | P3 | P4 | P5 | P6 | P7 | P8 | P9 |
| kneading | | parts by mass | 89.6 | 89.6 | 89.6 | 70.0 | 70.0 | 70.0 | 89.6 | 89.6 | 89.6 |
| | Polybutadiene rubber *1 | parts by mass | 30 | 30 | 30 | 30 | 30 | 30 | 30 | 30 | 30 |
| | Surfactant | type | — | — | — | — | — | — | — | — | — |
| | | parts by mass | — | — | — | — | — | — | — | — | — |
| | | HLB | — | — | — | — | — | — | — | — | — |
| | Extender oil *2 | parts by mass | 12.5 | 12.5 | 12.5 | 30 | 30 | 30 | 12.5 | 12.5 | 12.5 |
| | Silica *3 | parts by mass | 70 | 70 | 70 | 70 | 70 | 70 | 70 | 70 | 70 |
| | Silane coupling agent *4 | parts by mass | 6 | 6 | 6 | 6 | 6 | 6 | 6 | 6 | 6 |
| | Stearic acid | parts by mass | 2 | 2 | 2 | 2 | 2 | 2 | 2 | 2 | 2 |
| | Antiaging agent *5 | parts by mass | 1 | 1 | 1 | 1 | 1 | 1 | 1 | 1 | 1 |
| | Zinc oxide | parts by mass | 3 | 3 | 3 | 3 | 3 | 3 | 3 | 3 | 3 |
| Second- | Vulcanization accelerator 1 *6 | parts by mass | 1.5 | 1.5 | 1.5 | 1.5 | 1.5 | 1.5 | 1.5 | 1.5 | 1.5 |
| stage | Vulcanization accelerator 2 *7 | parts by mass | 1.8 | 1.8 | 1.8 | 1.8 | 1.8 | 1.8 | 1.8 | 1.8 | 1.8 |
| kneading | Sulfur | parts by mass | 1.5 | 1.5 | 1.5 | 1.5 | 1.5 | 1.5 | 1.5 | 1.5 | 1.5 |
| Physical | MV (ML1 + 4, 100° C.] | index | 105 | 117 | 110 | 105 | 114 | 109 | 111 | 145 | 200 |
| properties | 3% tanδ@50° C. | index | 102 | 107 | 105 | 102 | 105 | 105 | 101 | 120 | 40 |
| of | Δtanδ | index | 102 | 107 | 105 | 102 | 105 | 105 | 101 | 115 | 40 |
| formulation | M300 | index | 101 | 103 | 102 | 101 | 103 | 102 | 100 | 108 | 55 |

| | | | Compar- | Compar- | Compar- | Compar- | Compar- | Compar- |
|---|---|---|---|---|---|---|---|---|
| | | | ative | ative | ative | ative | ative | ative |
| | | | Exam- | Exam- | Exam- | Exam- | Exam- | Exam- |
| <Production of Formulation Q> | | | ple 8 | ple 9 | ple 10 | ple 11 | ple 12 | ple 13 |
| Name of formulation Q | | | Q10 | Q11 | Q12 | Q13 | Q14 | Q15 |
| First-stage | Polymer composition P | type | P10 | P11 | P12 | P13 | P14 | P10 |
| kneading | | parts by mass | 87.5 | 89.6 | 89.6 | 89.6 | 70.0 | 87.5 |
| | Polybutadiene rubber *1 | parts by mass | 30 | 30 | 30 | 30 | 30 | 30 |
| | Surfactant | type | — | — | — | — | — | a-1 |
| | | parts by mass | — | — | — | — | — | 1.6 |
| | | HLB | — | — | — | — | — | 6.4 |
| | Extender oil *2 | parts by mass | 12.5 | 12.5 | 12.5 | 12.5 | 30 | 12.5 |
| | Silica *3 | parts by mass | 70 | 70 | 70 | 70 | 70 | 70 |
| | Silane coupling agent *4 | parts by mass | 6 | 6 | 6 | 6 | 6 | 6 |
| | Stearic acid | parts by mass | 2 | 2 | 2 | 2 | 2 | 2 |
| | Antiaging agent *5 | parts by mass | 1 | 1 | 1 | 1 | 1 | 1 |
| | Zinc oxide | parts by mass | 3 | 3 | 3 | 3 | 3 | 3 |
| Second- | Vulcanization accelerator 1 *6 | parts by mass | 1.5 | 1.5 | 1.5 | 1.5 | 1.5 | 1.5 |
| stage | Vulcanization accelerator 2 *7 | parts by mass | 1.8 | 1.8 | 1.8 | 1.8 | 1.8 | 1.8 |
| kneading | Sulfur | parts by mass | 1.5 | 1.5 | 1.5 | 1.5 | 1.5 | 1.5 |
| Physical | MV (ML1 + 4, 100° C.] | index | 100 | 99 | 97 | 95 | 160 | 99 |
| properties | 3% tanδ@50° C. | index | 100 | 94 | 89 | 83 | 60 | 95 |
| of | Δtanδ | index | 100 | 95 | 90 | 85 | 65 | 96 |
| formulation | M300 | index | 100 | 96 | 92 | 87 | 65 | 95 |

*1: BR01, manufactured by ENEOS Materials Corporation
*2: NC-140, manufactured by ENECS Corporation
*3: ZEOSIL 1165MP, manufactured by Rhodia
*4: Si75, manufactured by Evonik
*5: Ozonone 6C, N-(1,3-dimethylbuthyl)-N′-phenyl-p-phenylenediamine, manufactured by Seiko Chemical Co., Ltd.
*6: Nocceler D, 1,3-diphenylguanidine, manufactured by Ouchi Shinko Chemical Industrial Co., Ltd.
*7: Nocceler CZ, N-Cyclohexy1-2-benzothiazolylsulfenamide, manufactured by Ouchi Shinko Chemical Industrial Co., Ltd.

As shown in Table 1 and Table 2, when the polymer solution containing the modified conjugated diene-based polymer and the surfactant having an HLB value of 9.0 or less and having an oxypropylene group (—C₃H₆—O—) were mixed together and then the solvent was removed from the liquid mixture, it was possible to improve the transportability of discharged water that was generated at the time of producing the polymer composition while suppressing the contamination of the discharged water and to obtain a polymer composition in which a change in the physical properties after long-term storage was suppressed (Examples 1 to 8). In addition, as shown in Examples 9 to 16, the crosslinked rubbers produced using the polymer compositions of Examples 1 to 8 were also excellent in terms of low fuel consumption performance, filler dispersibility and tensile characteristics. Furthermore, the formulations obtained by blending silica or the like with the polymer compositions of Examples 1 to 8, respectively, were also favorable in terms of processability.

In contrast, in Comparative Example 2 where the polymer composition was produced in the same manner as in Example 1 except that the surfactant was not added to the polymer composition, Comparative Example 3 where the surfactant having no oxypropylene group (—C₃H₆—O—) was used, Comparative Example 4 and Comparative Example 5 where the surfactant having an HLB value of more than 9.0 and having no oxypropylene group was used and Comparative Example 6 where the modified conjugated diene-based polymer having a molecular weight distribution Mw/Mn of less than 1.50 was used, at least any characteristic of processability, a change in physical properties after long-term storage, the degree of contamination of discharged water that was generated at the time of producing the polymer composition and the transportability of discharged water was poorer than that of Examples 1 to 8. In addition, as shown in Comparative Examples 8 to 12, the polymer compositions of Comparative Examples 2 to 6 were poorer than the crosslinked rubbers (Examples 9 to 16) produced from the polymer compositions of Examples 1 to 8, respectively, in terms of all characteristics of low fuel consumption performance, silica dispersibility and tensile characteristics when used to produce the crosslinked products.

In addition, Comparative Example 1 where the terminal unmodified conjugated diene-based polymer was used was equivalent to those of Examples 1 to 8 in terms of a change in physical properties after long-term storage, the degree of contamination of discharged water that was generated at the time of producing the polymer composition and the transportability of discharged water, but was significantly poorer than the crosslinked rubbers produced from the polymer compositions of Examples 1 to 8, respectively, in terms of low fuel consumption performance, filler dispersibility and tensile characteristics when used to produce the crosslinked product as shown in Comparative Example 7. Furthermore, Comparative Example 13 where, instead of adding the surfactant to the polymer solution, the surfactant was blended at the time of the first-stage kneading (that is, the polymer composition P10 not containing the surfactant (B) was used instead of using the polymer composition P containing the modified conjugated diene-based polymer (A) and the surfactant (B) and the surfactant was blended at the time of the first-stage kneading) was poor compared with Examples 9 to 16 in terms of all characteristics of low fuel consumption performance, silica dispersibility and tensile characteristics.

The above-described results show that, when the polymer composition P containing the polymer solution containing the modified conjugated diene-based polymer and the surfactant having an HLB value of 9.0 or less and having an oxypropylene group (—C₃H₆—O—) was produced, it was possible to improve the transportability of discharged water that was generated at the time of producing the polymer composition, which is used to produce rubber products, while suppressing the contamination of the discharged water and to obtain a polymer composition in which a change in the physical properties after long-term storage was suppressed. In addition, it has been clarified that the polymer composition has excellent processability and a crosslinked product that is obtained using the polymer composition is excellent in terms of low fuel consumption performance, filler dispersibility and tensile characteristics.

What is claimed is:

1. A polymer composition comprising:
(A) a modified conjugated diene-based polymer which comprises a monomer unit derived from a conjugated diene compound and has a molecular weight distribution Mw/Mn of 1.50 to 3.00 and in which some or all of molecules are modified, the molecular weight distribution being represented by a ratio of polystyrene-equivalent weight-average molecular weight Mw to number-average molecular weight Mn measured by gel permeation chromatography; and
(B) a surfactant having HLB of 9.0 or less and comprising an oxypropylene group (—C₃H₆—O—),
the polymer composition further comprising:
(C) an extender oil as an optional component, wherein a total amount of the modified conjugated diene-based polymer (A), the surfactant (B) and the extender oil (C) is 95 mass % or more based on the entire composition.

2. The polymer composition according to claim 1, wherein the surfactant (B) is at least one selected from the group consisting of compounds represented by a compound represented by formula (1) and a compound represented by formula (2): 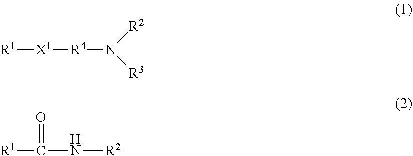
wherein R¹ is a hydrocarbyl group having 10 to 18 carbon atoms, R² is —(R⁶O)ᵣ₁—H, and R³ is a hydrocarbyl group or —(R⁷O)ᵣ₂—H; R⁶ is an ethylene group, a propane-1,2-diyl group or a propane-1,3-diyl group, r1 is an integer of 1 or more, in a case where r1 is 1, R⁶ is a propane-1,2-diyl group or a propane-1,3-diyl group, and in a case where r1 is 2 or more, a plurality of R⁶ is the same as or different from each other, and at least one of the plurality of R⁶ is a propane-1,2-diyl group or a propane-1,3-diyl group; R⁷ is an ethylene group, a propane-1,2-diyl group or a propane-1,3-diyl group, r2 is an integer of 1 or more, and in a case where r2 is 2 or more, a plurality of R⁷ is the same as or different from each other; X¹ is a single bond, an oxygen atom or —NR⁵—; R⁴ is a single bond in a case where X¹ is a single bond, and is a hydrocarbylene group in a case where X¹ is an oxygen atom or —NR⁵—; R⁵ is a hydrogen atom, a hydrocarbyl group or —(R⁸O)ᵣ₃—H; and R⁸ is an ethylene group, a propane-1,2-diyl group or a propane-1,3-diyl group, r3 is an integer of 1 or more, and in a case where r3 is 2 or more, a plurality of R⁸ is the same as or different from each other.

3. The polymer composition according to claim 1, wherein 0.05 to 10 parts by mass of the surfactant (B) is comprised per 100 parts by mass of the modified conjugated diene-based polymer (A).

4. The polymer composition according to claim 1, wherein the modified conjugated diene-based polymer (A) comprises a partial structure derived from a compound comprising a hydrocarbyloxysilyl group and a nitrogen-containing group in one molecule.

5. The polymer composition according to claim 1, wherein the polystyrene-equivalent weight-average molecular weight Mw of the modified conjugated diene-based polymer (A) measured by gel permeation chromatography is 1.0×10⁵ or more and 3.0×10⁶ or less.

6. The polymer composition according to claim 1, wherein a content rate of a component having a polystyrene-equivalent molecular weight measured by gel permeation chromatography of 2.0×10⁶ or more and 5.0×10⁶ or less in the modified conjugated diene-based polymer (A) is 0.5 mass % or more and 30 mass % or less.

7. The polymer composition according to claim 1, wherein the polymer composition comprises the extender oil (C).

8. The polymer composition according to claim 7, wherein 0.05 to 100 parts by mass of the extender oil (C) is comprised per 100 parts by mass of the modified conjugated diene-based polymer (A).

9. A formulation comprising:
the polymer composition according to claim 1; and
a reinforcing filler (D).

10. The formulation according to claim 9, wherein the reinforcing filler (D) is at least one selected from the group consisting of silica, carbon black and an inorganic compound represented by formula (3),
nM¹·mSiOₖ·iH₂O (3)
wherein M¹ is at least one selected from the group consisting of a specific metal that is any of aluminum, magnesium, titanium and calcium, an oxide of the specific metal, a hydroxide of the specific metal, a hydrate of an oxide of the specific metal and a hydrate of a hydroxide of the specific metal; n is an integer of 1 to 5; m is an integer of 0 to 10; k is an integer of 2 to 5; and i is an integer of 0 to 10.

11. A crosslinked product that is obtained using the formulation according to claim 9.

12. A tire, wherein either or both of a tread and a sidewall are formed of the formulation according to claim 9.

13. A method for producing a polymer composition, comprising:
mixing a polymer solution dissolving (A) a modified conjugated diene-based polymer in an organic solvent and (B) a surfactant to obtain a liquid mixture; and
removing the solvent from the liquid mixture obtained by the mixing, for desolvation,
wherein the modified conjugated diene-based polymer (A) comprises a monomer unit derived from a conjugated diene compound and has a molecular weight distribution Mw/Mn of 1.50 to 3.00 and in which some or all of molecules are modified, the molecular weight distribution being represented by a ratio of polystyrene-equivalent weight-average molecular weight Mw to number-average molecular weight Mn measured by gel permeation chromatography, and
wherein the surfactant (B) has HLB of 9.0 or less and comprises an oxypropylene group (—C₃H₆—O—).

14. The method for producing a polymer composition according to claim 13, wherein, in the desolvation, the liquid mixture comprising the polymer solution and the surfactant (B) is brought into contact with water to carry out desolvation.

15. The method for producing a polymer composition according to claim 13, wherein the polymer solution is obtained by continuously or intermittently adding at least one initiator selected from the group consisting of an alkali metal compound and an alkali earth metal compound, an organic solvent and a conjugated diene compound to a reaction vessel a plurality of times.

16. The method for producing a polymer composition according to claim 13, further comprising:
mixing an extender oil with the polymer solution, or with the liquid mixture of the polymer solution and the surfactant (B) before the desolvation.
